(19) United States
(12) Patent Application Publication
(10) Pub. No.: US 2026/0266120 A1
(43) Pub. Date: Sep. 10, 2026

(54) CONTROL DEVICE

(71) Applicant: Stabilus GmbH, Koblenz (DE)

(72) Inventors: Christian Einig, Brohl (DE); Rudolf Joos, Nassau (DE); Jonathan Kessler, Gemünden (DE); Martin Neitzert, Urbach (DE)

(21) Appl. No.: 19/165,952

(22) PCT Filed: Mar. 18, 2024
(86) PCT No.: PCT/DE2024/100214

§ 371 Date: Sep. 16, 2025

(30) Foreign Application Priority Data
Mar. 21, 2023 (DE) 102023107080.0

(51) Int. Cl. E05F 15/622

(52) U.S. Cl. CPC E05F 15/622; E05Y 2201/624; E05Y 2201/64; E05Y 2201/684; E05Y 2201/702; E05Y 2201/704; E05Y 2900/531

(57) ABSTRACT

The invention relates to an adjusting device (10) for a vehicle part that is movable relative to a body of a vehicle, in particular for a vehicle door or a vehicle flap, comprising:
a housing (24) with a slide assembly (26), wherein the slide assembly (26) can be transferred between a first position and a second position by means of a drive unit (14),
an adjusting element (28), which is designed to be connectable to the slide assembly (26) and the body of a vehicle or a vehicle part that is movable relative to the body of a vehicle, wherein
a fastening element (36) for fastening the adjusting device (10) to a body of a vehicle or to a vehicle part that is movable relative to the body of a vehicle, wherein the fastening element (36) is designed to be connectable to the housing (24) in a frictional and/or positive manner.

The invention relates to an adjusting device for a vehicle part that is movable relative to a body of a vehicle, in particular for a vehicle door or a vehicle flap.

An adjusting device of the type mentioned above is known, for example, from DE 10 2011 118 353 A1. It shows an adjusting device for the tailgate of a vehicle, the adjusting device comprising a spindle drive. The spindle drive has two spindle tubes that can be telescoped into one another.

DE 10 2019 214 037 A1 also relates to a spindle drive, wherein the spindle drive is connected to a pressure piston via a section tube. The section tube is frictionally fastened to a spindle nut of the spindle drive. Other adjusting devices that use spindle drives are known from practice. Such spindle drives usually have a large number of individual components so that the manufacture of such a spindle drive results in chain tolerances, which can contribute to increased noise generation, in particular if corresponding vibrations or tolerance-related oscillations are transmitted to a vehicle body or a vehicle part that is movable relative to the vehicle body.

Against this background, it is an object of the invention to specify an adjusting device for a vehicle part that is movable relative to a body of a vehicle, the adjusting device making good tolerance compensation possible, in particular during assembly, so that noise generation occurring during operation is reduced. It is also an object of the invention to specify a vehicle comprising such an adjusting device.

According to the invention, this object is achieved with regard to the adjusting device by the subject matter of claim 1 and with regard to the vehicle by the subject matter of claim 16.

Specifically, the object is achieved by an adjusting device for a vehicle part that is movable relative to the body of a vehicle, in particular for a vehicle door or a vehicle flap, preferably comprising a housing with a slide assembly, wherein the slide assembly can be transferred between a first position and a second position by means of a drive unit. Furthermore, an adjusting element is provided, which is designed to be connectable to the slide assembly and the body of a vehicle or to a vehicle part that is movable relative to the body of a vehicle. In the invention, a fastening element for fastening the actuating device to a body of a vehicle or to a vehicle part that is movable relative to the body of a vehicle can also be provided, wherein the fastening element is designed to be connectable to the housing in a frictional and/or positive manner.

The adjusting element is designed in particular to be connectable to the slide assembly and the body of a vehicle or a vehicle part that is movable relative to the body of a vehicle.

The ball joint connection allows in particular a linkage and movement of the adjusting element about a pivot axis, which, for example, runs orthogonally to a longitudinal axis of the adjusting element and, for example, through the ball bolt. In particular, the pivot axis of the adjusting element also runs through the slide assembly.

The invention has the advantage that the separate fastening element allows tolerance compensation when mounting the adjusting device on a vehicle. The fact that the fastening element is connectable to the housing in a frictional and/or positive manner also makes mounting easier. In particular, no mounting templates are required. Rather, before the frictional engagement and/or the positive engagement are established, a position of the housing in relation to the fastening element can be adjusted to compensate for the tolerances. Manufacturing tolerances, in particular tolerance chains, can thus be easily and simply compensated for when mounting the adjusting device on the vehicle. This reduces tension and acoustic impairments that can result from the transmission of vibrations to the vehicle body.

In a preferred embodiment of the adjusting device according to the invention, it is provided that the housing has at least one receptacle for guiding the fastening element along a longitudinal direction of the housing. Such a guide for the fastening element allows particularly simple tolerance compensation during mounting. In particular, the fastening element can be fastened or fixed at different positions along the receptacle so that an optimal position for the adjusting device can be found for the particular vehicle.

Preferably, the fastening element comprises at least one guide device for insertion into the receptacle. Such a guide device facilitates the mounting of the fastening device on the housing of the adjusting device. At the same time, such a guide element can ensure that torsion of the fastening element relative to the housing of the actuating device is avoided.

The guide device preferably has a first guide element and a second guide element.

Such a dual guide of the guide device on the housing ensures particularly good force absorption. Tilting moments and other forces that occur transversely to a longitudinal axis of the adjusting device can thus be easily absorbed and compensated by the guide device.

The dual guide can be further improved by inserting the first guide element and the second guide element into the receptacle on opposite sides of the housing in a cross-sectional view.

In a preferred embodiment, the receptacle of the housing has at least two longitudinal grooves, which correspond to the first guide element and the second guide element. Accordingly, the fastening element can have at least two guide elements corresponding to the longitudinal grooves. In this way, a two-point bearing of the fastening element on the housing of the actuating device is achieved, which offers particularly high stability and at the same time keeps the component and material costs to a minimum. For example, the receptacle of the housing may also have three or more longitudinal grooves, which correspond to the corresponding number and position of guide elements on the fastening element.

In a further preferred embodiment of the adjusting device according to the invention, the guide elements are arranged parallel to one another. The parallel arrangement of the, in particular at least two, guide elements makes it possible to move the fastening element along the housing. During mounting, this movability is advantageous in order to compensate for the manufacturing tolerances of the adjusting device and to make mounting as simple as possible. Preferably, the fastening element is only finally fixed when the housing of the actuating device and the fastening element are correctly aligned with each other, i.e., corresponding manufacturing tolerances and tolerance chains have been compensated.

It is also advantageous if at least one guide element is conically shaped at a first end and at a second end. The guide elements or the at least one guide element should advantageously cooperate with at least one longitudinal groove of the receptacle on the housing. In order to easily connect the guide element with the longitudinal groove, a conical or frustoconical shape of the ends of the guide element is advantageous. In this way, the guide element is self-centered in the longitudinal groove. In addition, the insertion of the guide element into the longitudinal groove is facilitated. Overall, such a design makes mounting considerably easier, thereby speeding up the overall mounting process. For example, each guide element of the fastening element has a conical shape at a first end and at a second end.

The guide element may also have a preloading element for generating a preload of the fastening element relative to the housing. The preloading element can in particular act as a rotation prevention mechanism, i.e., prevent the guide element from twisting in the receptacle or the longitudinal groove. This prevents the fastening element from canting when mounted on the housing, which also makes mounting easier.

In general, the fastening element can have preloading elements in the form of longitudinally formed ribs for contact with the housing. In particular, additional preloading elements can be provided, which are formed outside the guide elements on the fastening element. Such preloading elements can be used as a tolerance compensation or preloading element relative to the housing so that rattling noises due to mechanical play can be excluded during vehicle operation. This makes it easier to move the fastening element along the housing, in particular for mounting purposes, before the final position of the fastening element is reached and fixed. The additional preloading elements on the fastening element can also be used to provide tolerance compensation. For this purpose, the fastening element can be made of a plastics material, for example, so that the preloading elements formed on the fastening element have a certain elasticity in order to compensate for housing tolerances. In any case, the preloading elements on the fastening element have the additional advantage that transmission surfaces for vibration transmission are reduced, thereby minimizing acoustic impairments caused by the adjusting device.

In a further preferred embodiment of the adjusting device according to the invention, the fastening element is fixed to the housing by crimping a receptacle with an inserted guide element. The fastening element can thus initially be positively connected to the housing by means of the guide elements and the longitudinal grooves, wherein the fastening element is movable along the longitudinal grooves. During mounting, this movability is used advantageously to optimally align the fastening element relative to the housing. Once the fastening element is correctly aligned relative to the housing, final fixation can be achieved by crimping the longitudinal grooves. The longitudinal groove can be reshaped such that it forms an additional positive engagement with the guide element, the additional positive engagement also acting in the longitudinal direction of the longitudinal groove. In other words, the fastening element is thus firmly fixed in its position relative to the housing. Crimping is particularly easy to accomplish and thus also facilitates the mounting of the adjusting device on a vehicle while simultaneously compensating for tolerances.

Alternatively or additionally, the fastening element can be fixed to the housing by riveting. It is thus possible to provide a riveted connection between the fastening element and the housing instead of reshaping the housing by crimping the longitudinal grooves. However, the riveted connection can also be provided in addition to the crimping of the longitudinal groove with the guide element. A riveted connection is also easy to establish and cost-effective. In addition, a riveted connection provides a particularly stable fastening of the fastening element to the housing.

The housing can be made of an aluminum profile or have an extruded profile comprising aluminum. On the one hand, such a housing is particularly stable and, on the other hand, offers a low mass, which is advantageous with regard to the aspect of lightweight construction in vehicle construction. The use of an aluminum profile, in particular an extruded profile made of aluminum, is more cost-effective, in particular in series production.

A further preferred embodiment of the invention can provide that the fastening element has a threaded portion with a funnel-shaped feed for fastening to a body of a vehicle or to a vehicle part that is movable relative to the body of a vehicle. The threaded portion can, for example, receive a screw or a threaded rod in order thus to connect the fastening element in a simple and detachable manner to a body of a vehicle or to a vehicle part that is movable relative to the body of a vehicle.

A further embodiment of the adjusting device advantageously provides that the fastening element is manufactured by means of an injection-molding process. In other words, the fastening element can be formed by an injection-molded part. Preferably, the threaded portion of the fastening element has an overmolded nut. The nut is preferably overmolded with a plastics material. The nut itself can be made of a metal. The use of an overmolded nut as part of the threaded portion is advantageous since it allows standardized components, in particular the nut, to be used, which reduces the overall component costs. At the same time, a nut made of a metallic material offers high stability while the overmolding provides acoustic decoupling. Vibrations generated in the adjusting device are hardly transmitted or at best transmitted in a dampened manner by the plastics material of the overmolded nut to the body or to a vehicle part that is movable relative to the body.

According to a further advantageous embodiment of the adjusting device, the fastening element comprises a holding means for cables, in particular a cable clip. For example, power cables, sensor cables, or fluid-carrying cables can be fixed by a holding means on the fastening element.

A coordinate aspect of the invention relates to a vehicle comprising an above-described adjusting device. The present invention relates to an adjusting device for a vehicle part that is movable relative to a body of a vehicle, in particular for a vehicle door or a vehicle flap.

The present invention will be described below with reference to several embodiments. Identical or like or similar components are provided with the same reference sign. The drawings, the description, and the claims contain numerous features in combination. A person skilled in the art will expediently also consider the features individually and combine them to form expedient further combinations. Individual or multiple exemplary embodiments can therefore advantageously be combined with one another.

In the drawings:

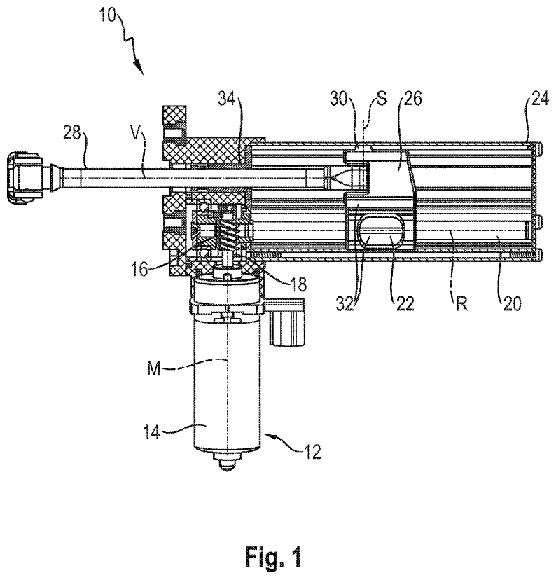

FIG. 1 is a side cross-sectional view of an exemplary embodiment of an adjusting device according to the invention;

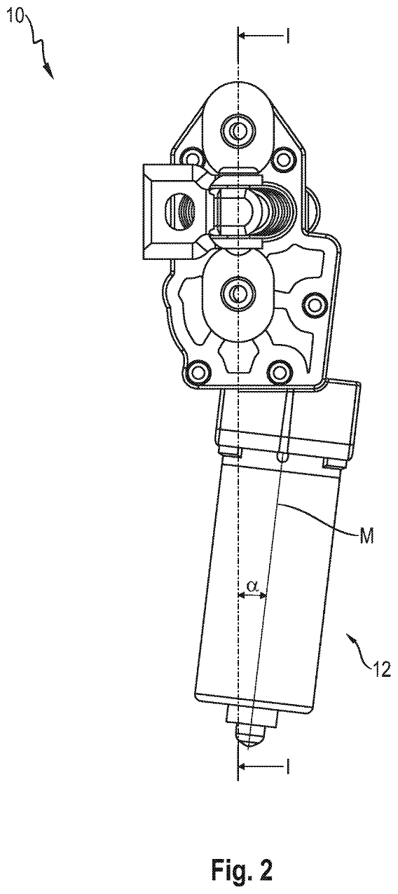

FIG. 2 is a side view of the adjusting device of FIG. 1;

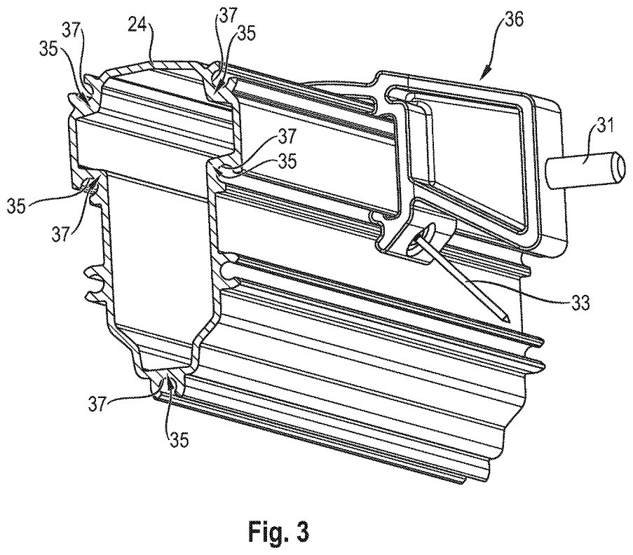

FIG. 3 is a spatial representation of a housing of a further exemplary embodiment of an adjusting device according to the invention;

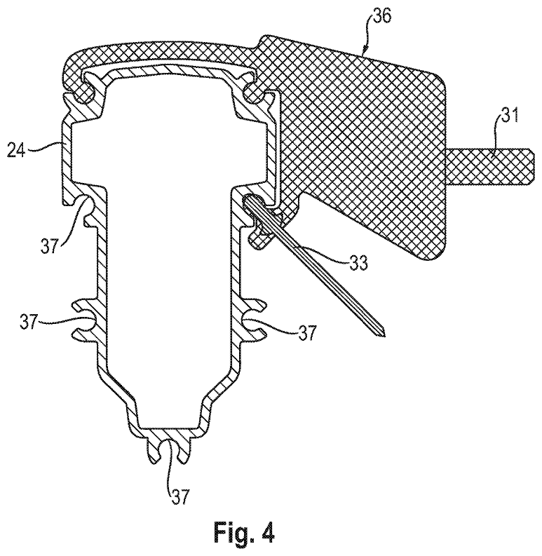

FIG. 4 shows a cross section of the housing of the adjusting device of FIG. 3;

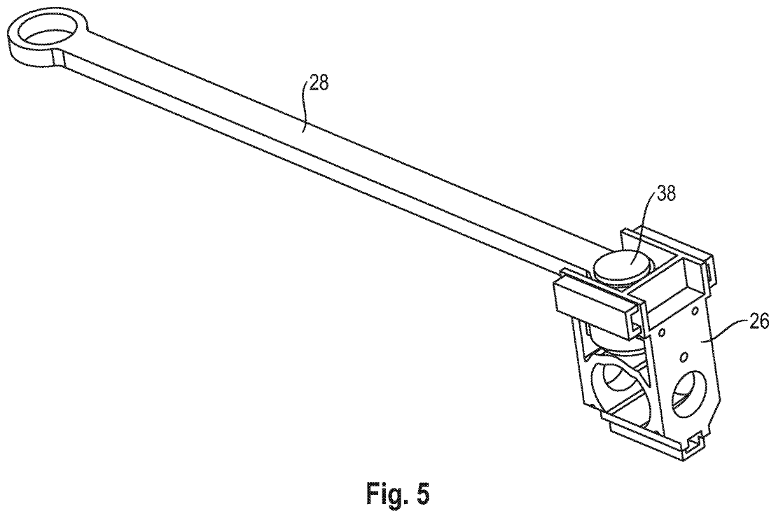

FIG. 5 is a spatial representation of a slide assembly with an articulated adjusting element of a further exemplary embodiment of an adjusting device according to the invention;

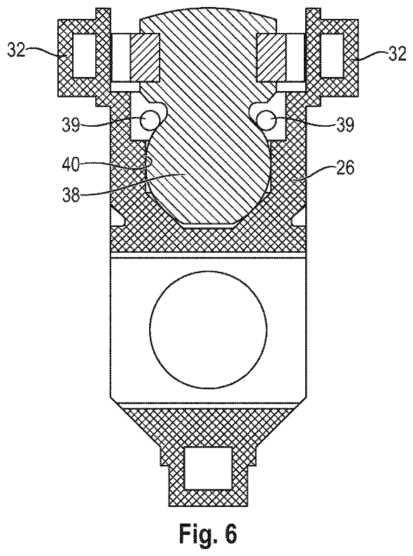

FIG. 6 shows a cross section of the slide assembly of FIG. 5;

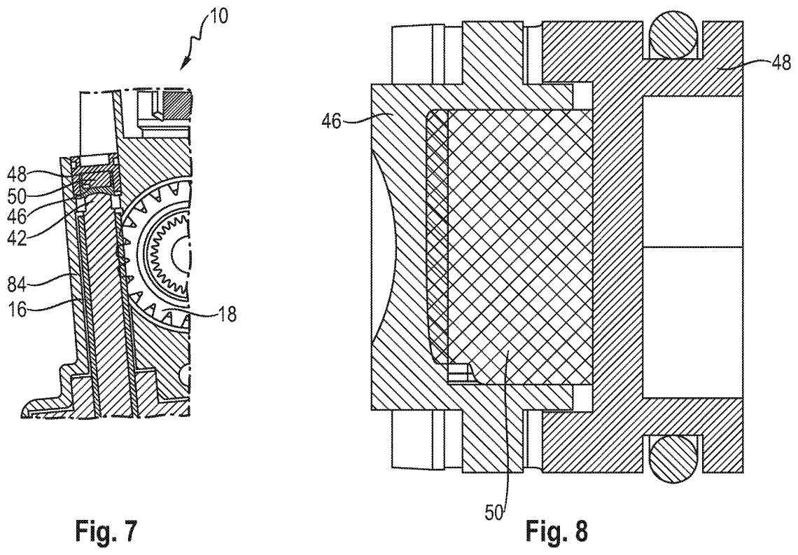

FIG. 7 shows a detail of a side cross section of a further exemplary embodiment of an adjusting device according to the invention;

FIG. 8 shows an enlarged cross section of a motor shaft preload assembly of FIG. 7;

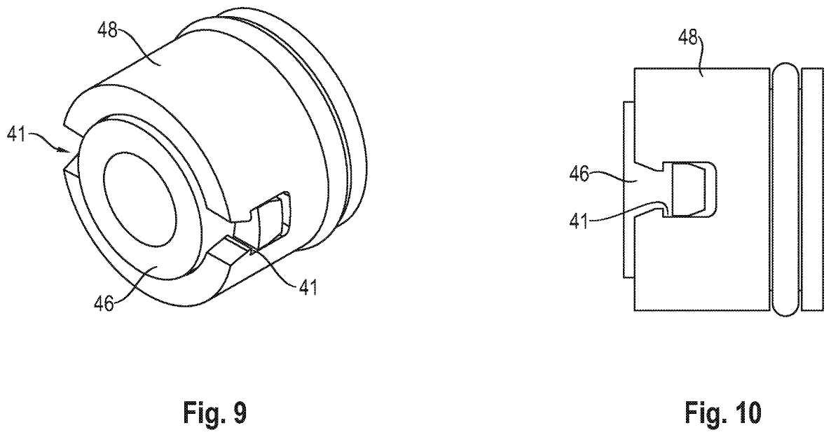

FIG. 9 is a spatial representation of the assembly of FIG. 8;

FIG. 10 is a side view of the assembly of FIG. 8;

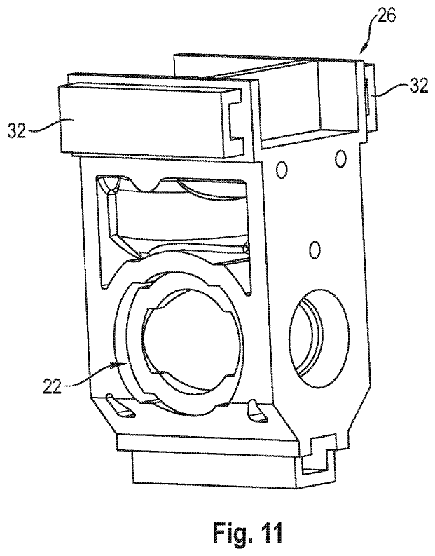

FIG. 11 is a spatial representation of a slide assembly with a spindle nut of a further exemplary embodiment of an adjusting device according to the invention;

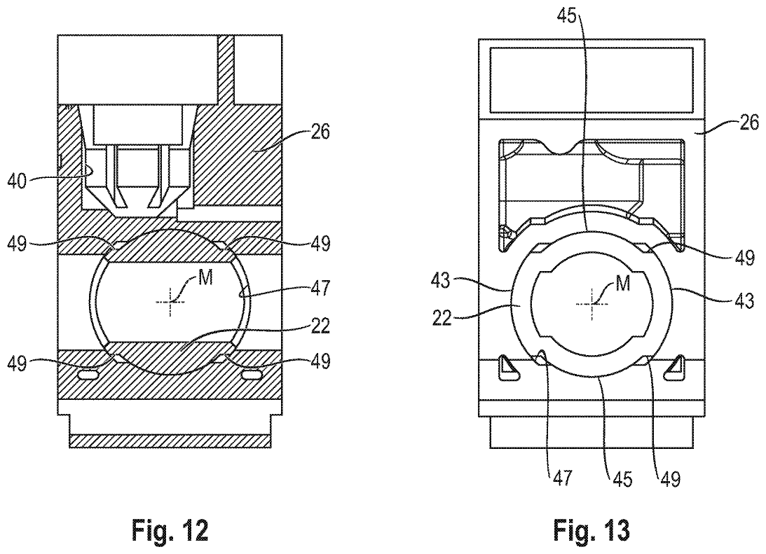

FIG. 12 shows a cross section of the slide assembly of FIG. 11;

FIG. 13 is a side view of the slide assembly of FIG. 11;

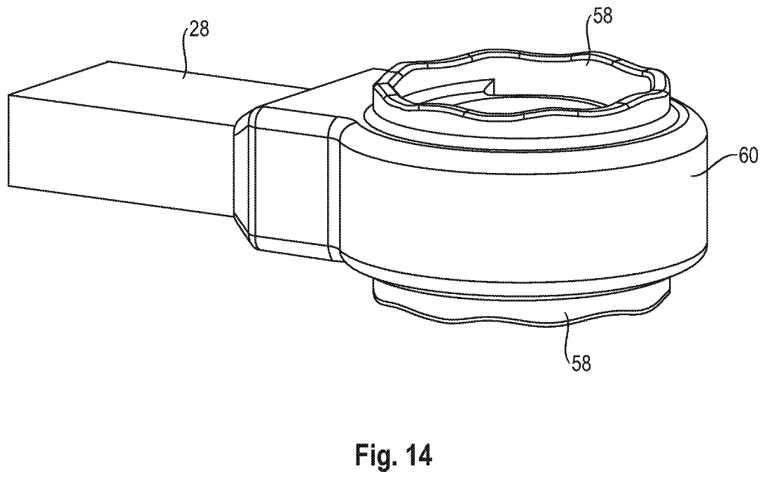

FIG. 14 is a spatial representation of a joint bearing of a further exemplary embodiment of an adjusting device according to the invention;

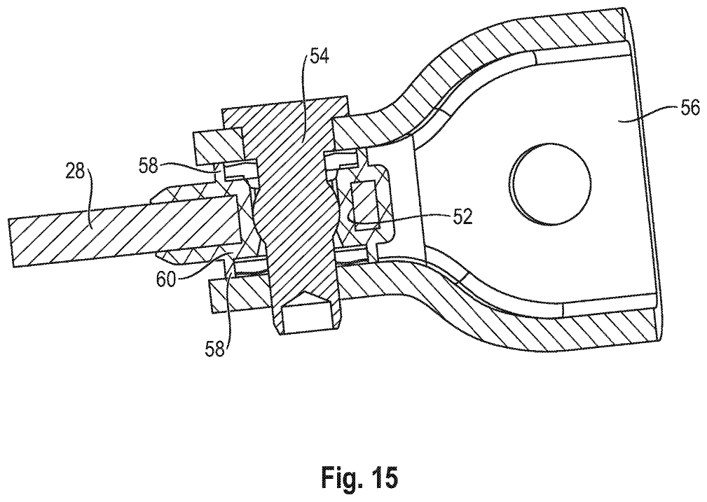

FIG. 15 shows a cross section of the joint bearing of FIG. 14;

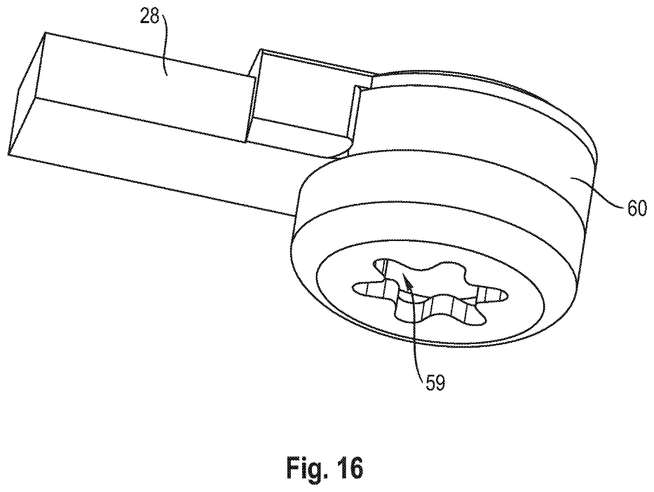

FIG. 16 is a spatial representation of a joint bearing of a further exemplary embodiment of an adjusting device according to the invention;

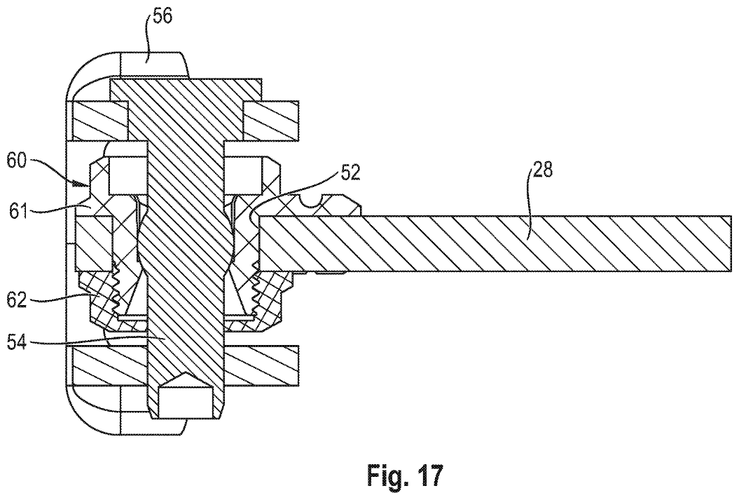

FIG. 17 shows a cross section of the joint bearing of FIG. 16 with joint bolt and retaining plate;

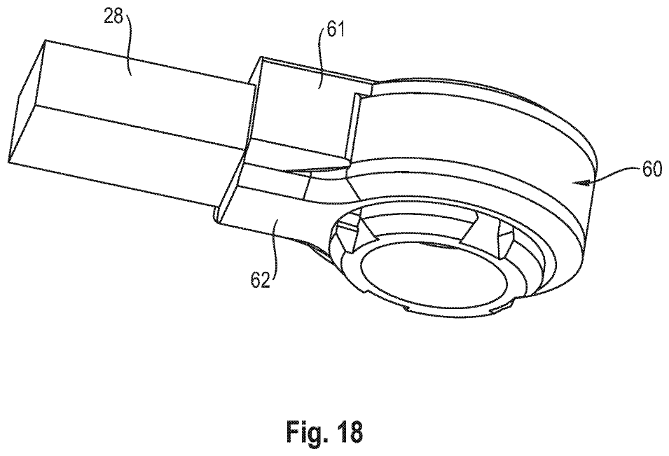

FIG. 18 is a spatial representation of a joint bearing of a further exemplary embodiment of an adjusting device according to the invention;

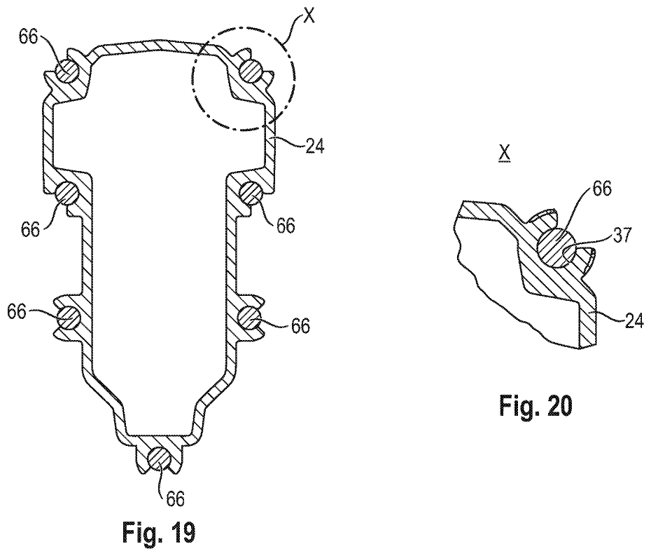

FIG. 19 shows a cross section of a housing with a cover of a further exemplary embodiment of an adjusting device according to the invention;

FIG. 20 shows an enlarged detail X of the housing with a cover of FIG. 19;

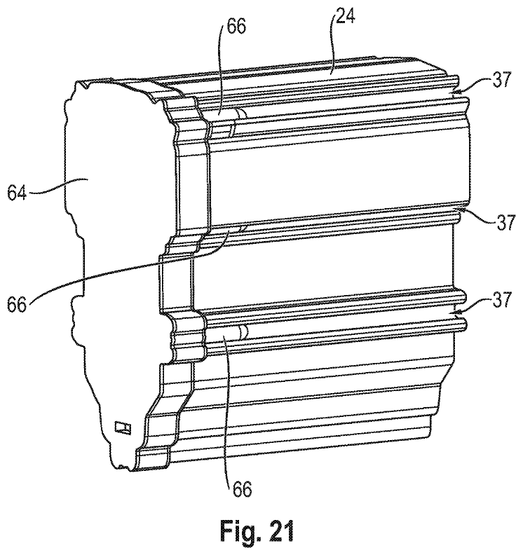

FIG. 21 is a spatial representation of the housing with a cover of FIG. 19;

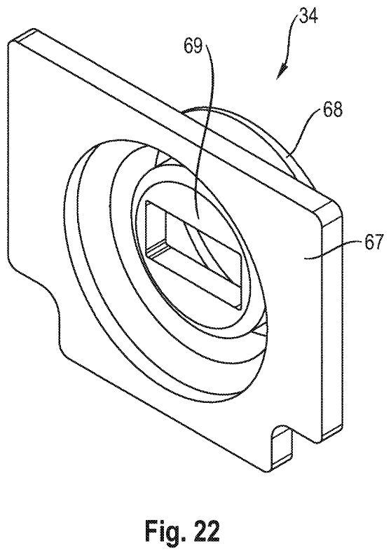

FIG. 22 is a spatial representation of a sealing arrangement of a further exemplary embodiment of an adjusting device according to the invention;

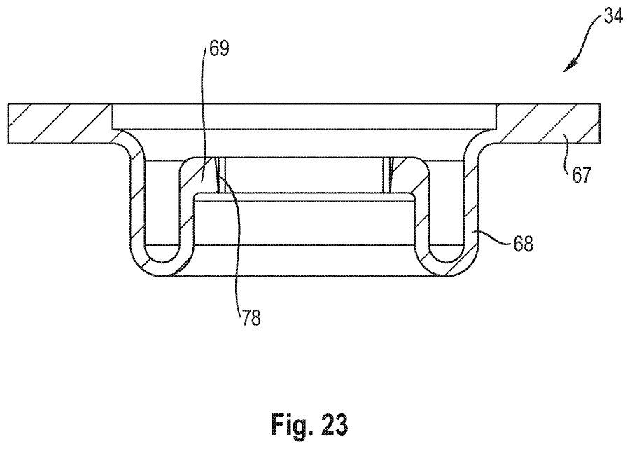

FIG. 23 shows a cross section of the sealing arrangement of FIG. 22;

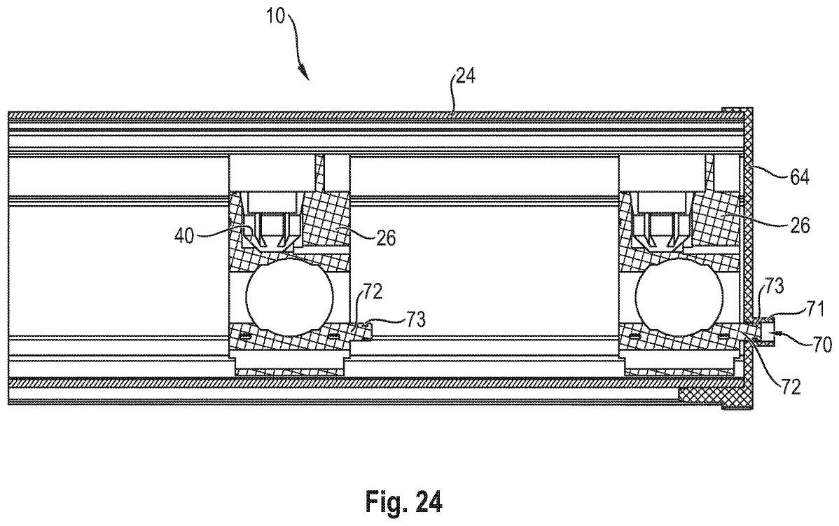

FIG. 24 is a side cross-sectional view of a further exemplary embodiment of an adjusting device according to the invention with two positions of the slide assembly;

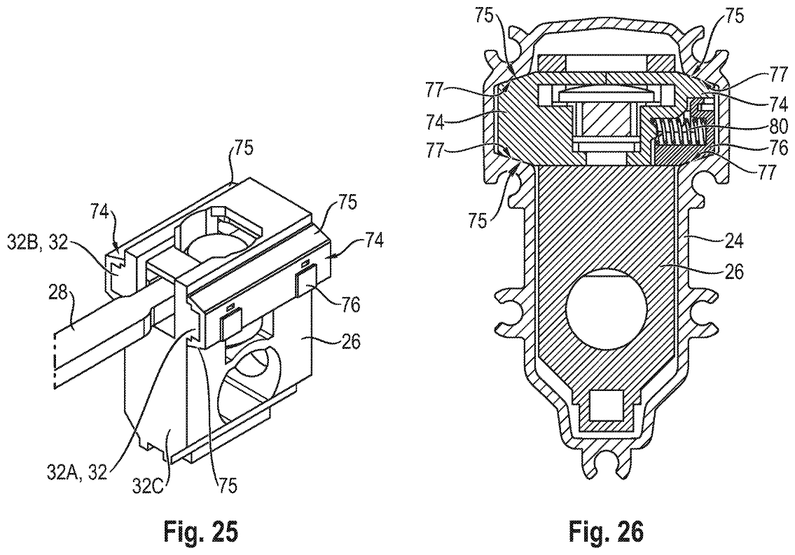

FIG. 25 is a spatial representation of a slide assembly with an articulated adjusting element of a further exemplary embodiment of an adjusting device according to the invention;

FIG. 26 shows a cross section of the slide assembly arranged in the housing as shown in FIG. 25;

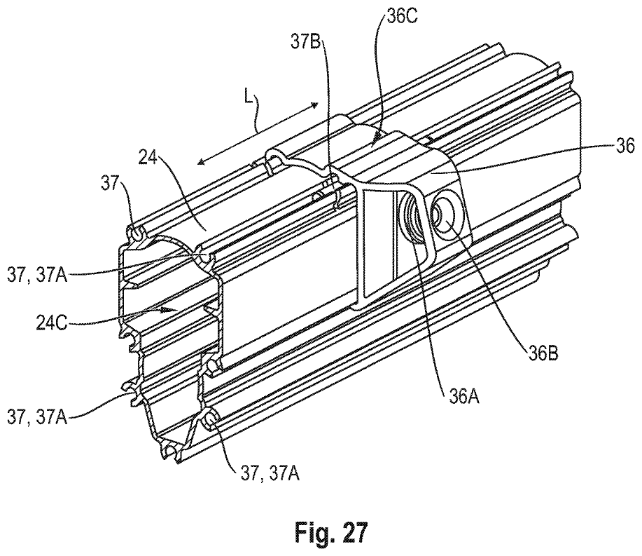

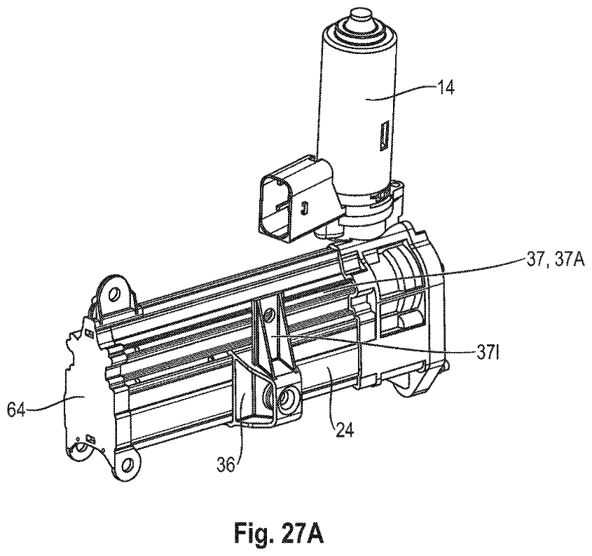

FIG. 27 is a perspective view of a housing of an adjusting device according to the invention according to a further, preferred exemplary embodiment with a fastening element for connecting to a vehicle;

FIG. 27A is a further perspective view of a housing of an adjusting device according to the invention according to an additional embodiment;

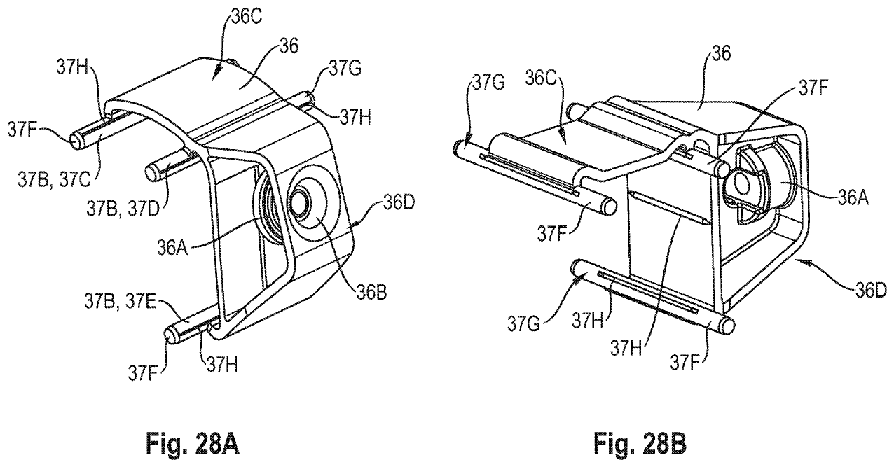

FIG. 28A is a perspective view of a fastening element comparable to the fastening element of the adjusting device as shown in FIG. 27;

FIG. 28B is a perspective rear view of the fastening element of the adjusting device as shown in FIG. 27;

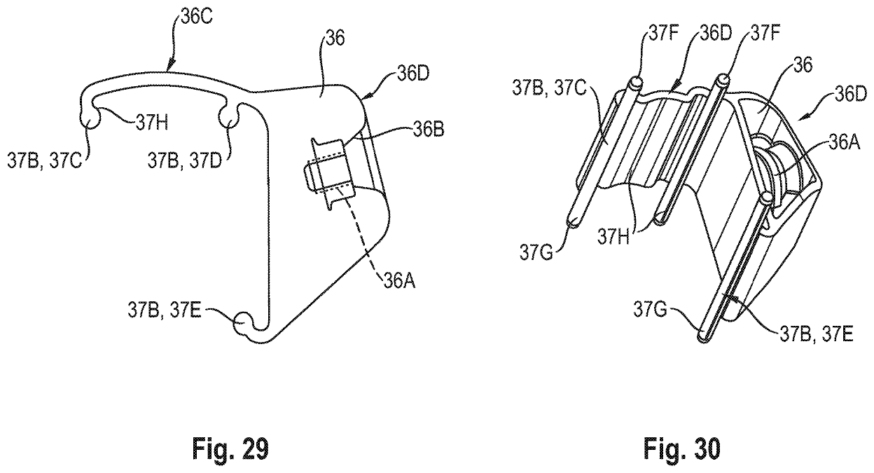

FIG. 29 is a cross-sectional view of the fastening element as shown in FIG. 28A;

FIG. 30 is a perspective bottom view of the fastening element as shown in FIG. 28A;

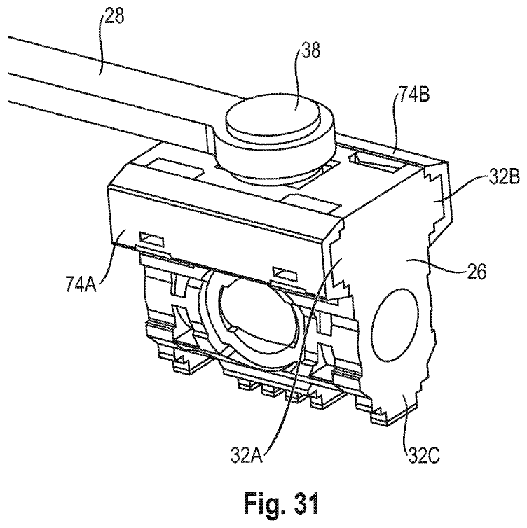

FIG. 31 is a perspective view of a slide assembly with an articulated adjusting element according to a preferred exemplary embodiment of the adjusting device according to the invention;

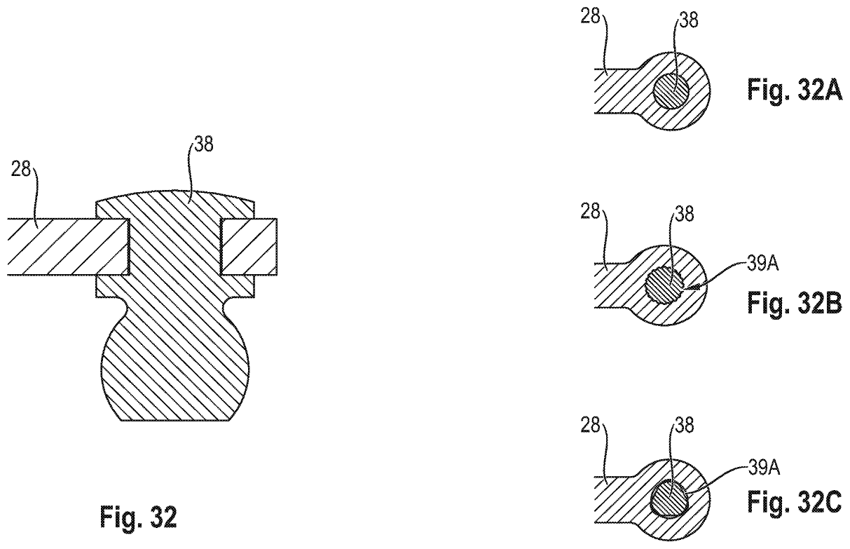

FIG. 32 shows a vertical section through the end of the adjusting element formed with a ball bolt as shown in FIG. 31;

FIG. 32A shows a horizontal section through the end of the adjusting element formed with a ball bolt as shown in FIG. 31;

FIG. 32B shows a horizontal section as shown in FIG. 32A, with the adjusting element having a rotation prevention mechanism for the ball bolt;

FIG. 32C shows a horizontal section as shown in FIG. 32A, with the adjusting element having an alternative rotation prevention mechanism for the ball bolt;

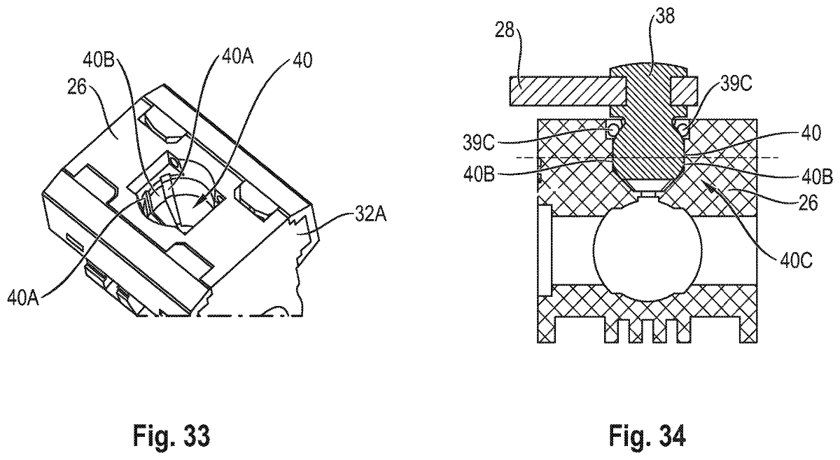

FIG. 33 is a perspective plan view of the slide assembly as shown in FIG. 31 without the articulated adjusting element;

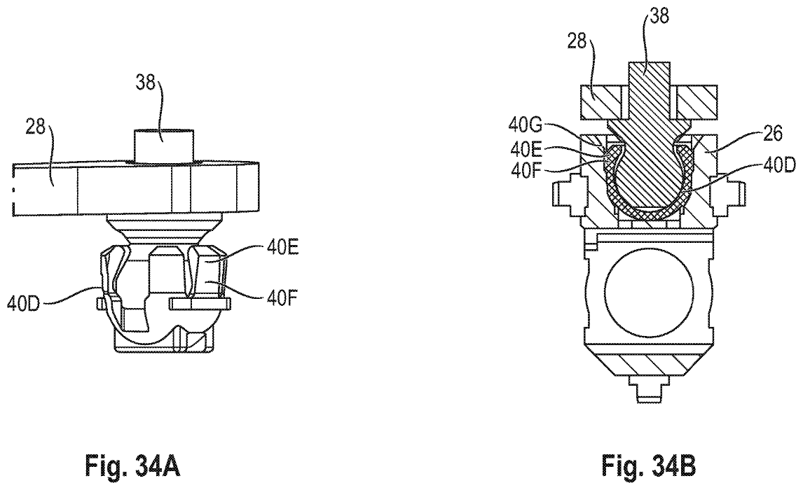

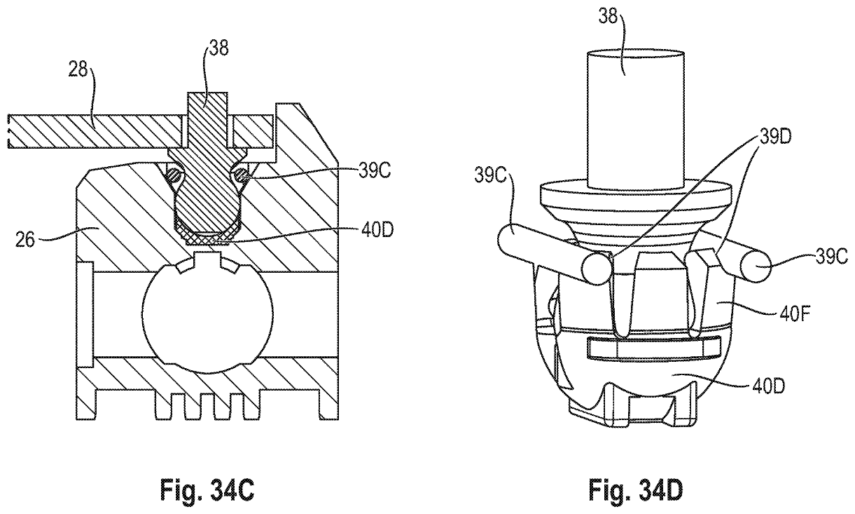

FIG. 34 shows a vertical section through the slide assembly as shown in FIG. 31;

FIG. 34A shows a ball bolt on an adjusting element according to a further exemplary embodiment of the adjusting device according to the invention;

FIG. 34B shows a vertical section through a slide assembly with a ball bolt as shown in FIG. 34A;

FIG. 34C shows a further vertical section through a slide assembly with a ball bolt as shown in FIG. 34A;

FIG. 34D is a perspective view of a ball bolt in a ball head receptacle in a further exemplary embodiment of the adjusting device according to the invention;

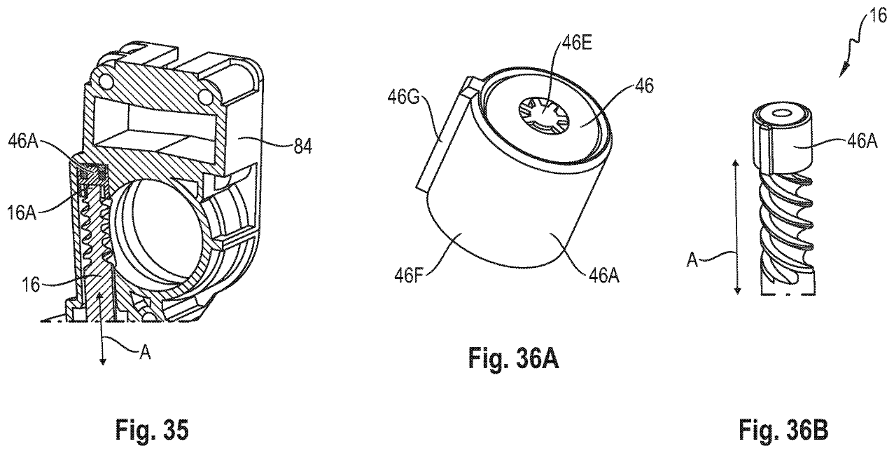

FIG. 35 is a perspective sectional view of the housing of the adjusting device according to the invention in the region of the drive element according to a preferred exemplary embodiment;

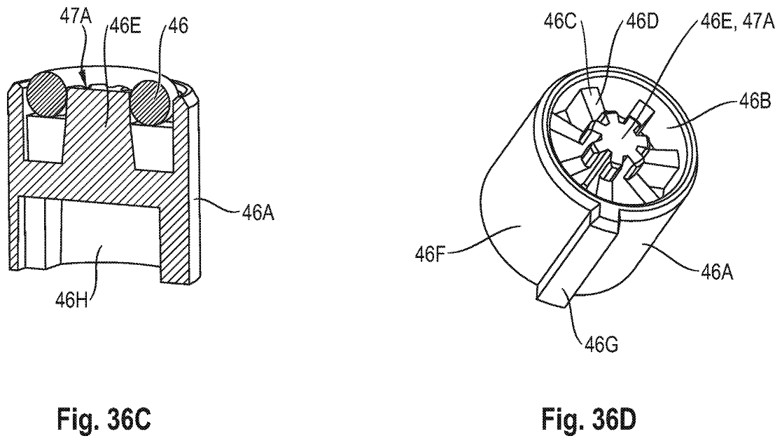

FIG. 36A is a perspective view of a plastics element for covering the free end of the drive element as shown in FIG. 35;

FIG. 36B is a perspective view of the drive element as shown in FIG. 35 with the plastics element as shown in FIG. 36A;

FIG. 36C is a sectional view of the plastics element as shown in FIG. 36A;

FIG. 36D is a perspective view of a plastics element of an adjusting device according to the invention according to a further, preferred exemplary embodiment;

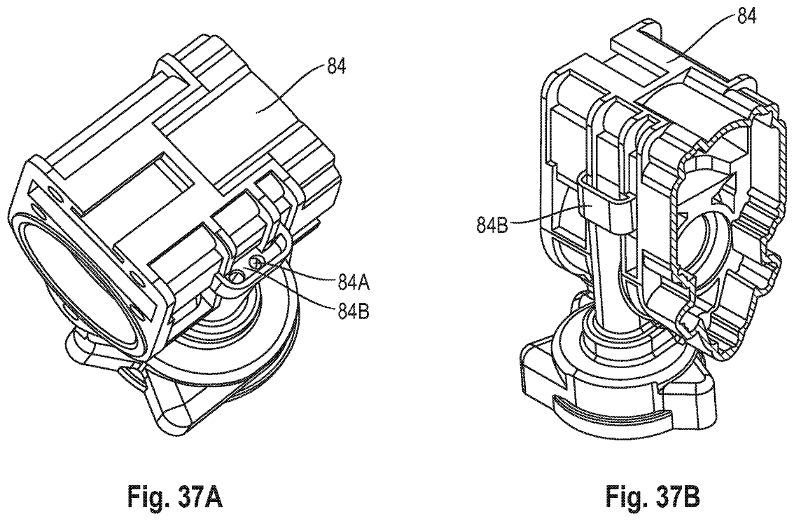

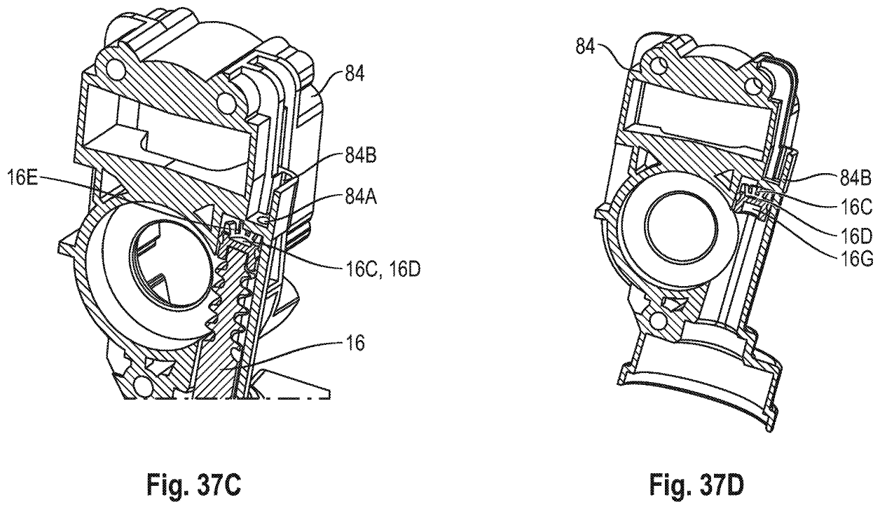

FIG. 37A is a perspective plan view of a housing for the drive unit with a storage tank for liquefied plastics material;

FIG. 37B is a perspective front view of the housing as shown in FIG. 37A;

FIG. 37C is a further perspective view of the housing for the drive unit with a storage tank for liquefied plastics material as shown in FIG. 37A;

FIG. 37D is a further perspective view of the housing for the drive unit with a storage tank for liquefied plastics material as shown in FIG. 37A;

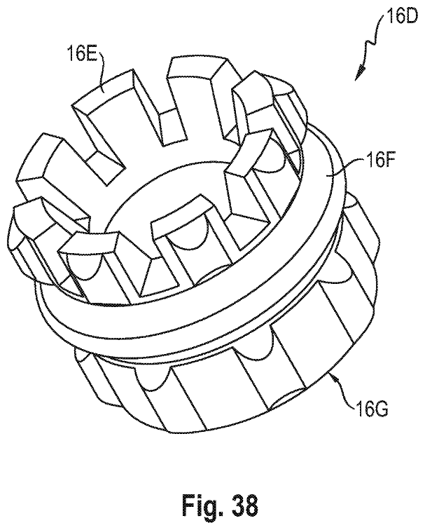

FIG. 38 is a perspective view of a bushing for placement between the drive element and the housing of the adjusting device;

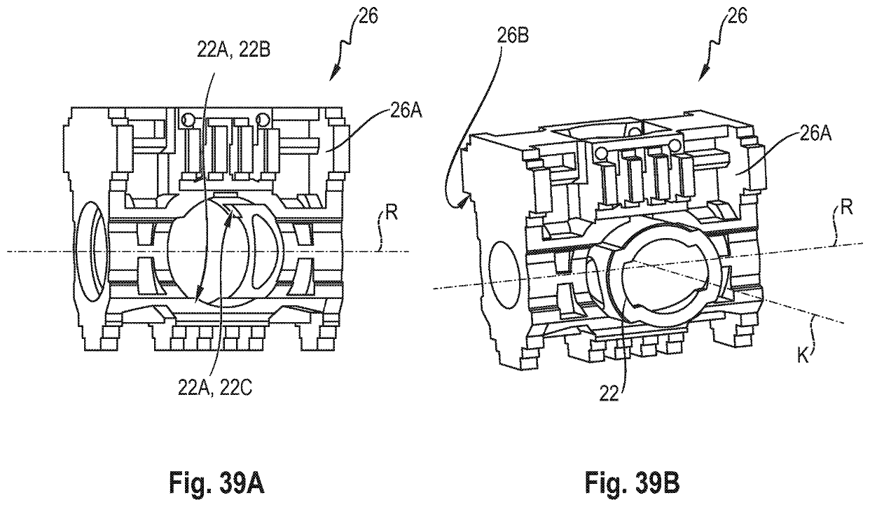

FIG. 39A is a perspective view of a slide assembly of the adjusting device according to the invention with a receiving opening for a spindle nut;

FIG. 39B is a further perspective view of the slide assembly as shown in FIG. 39A with the spindle nut inserted;

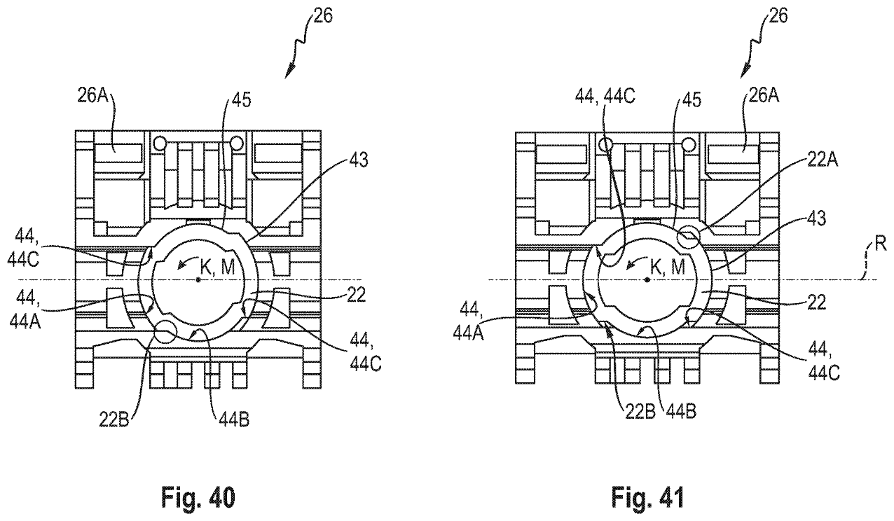

FIG. 40 is a side view of the slide assembly as shown in FIG. 39B, when inserting the spindle nut;

FIG. 41 is a side view of the slide assembly as shown in FIG. 39B with the spindle nut inserted;

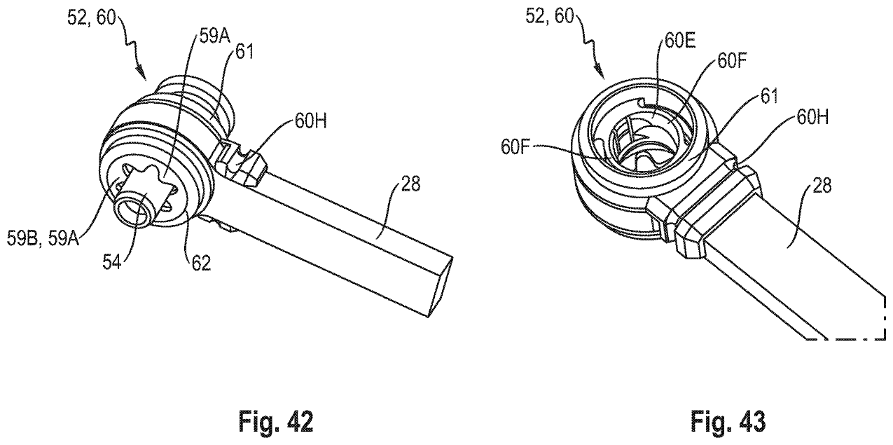

FIG. 42 is a perspective plan view of the joint bearing of the adjusting element with a two-part joint bearing insert, a second joint bearing insert element having a centering contour;

FIG. 43 is a perspective bottom view of the joint bearing as shown in FIG. 42;

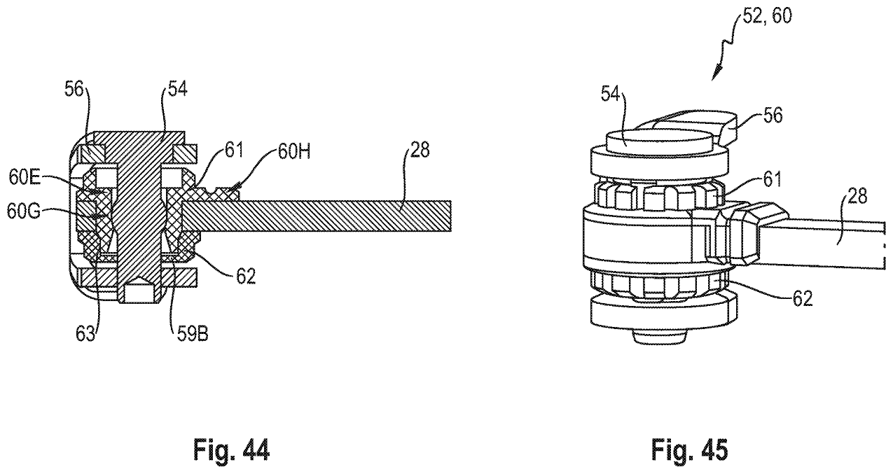

FIG. 44 is a sectional view of the joint bearing with inserted joint bolt according to a further exemplary embodiment;

FIG. 45 is a perspective side view of the joint bearing as shown in FIG. 44;

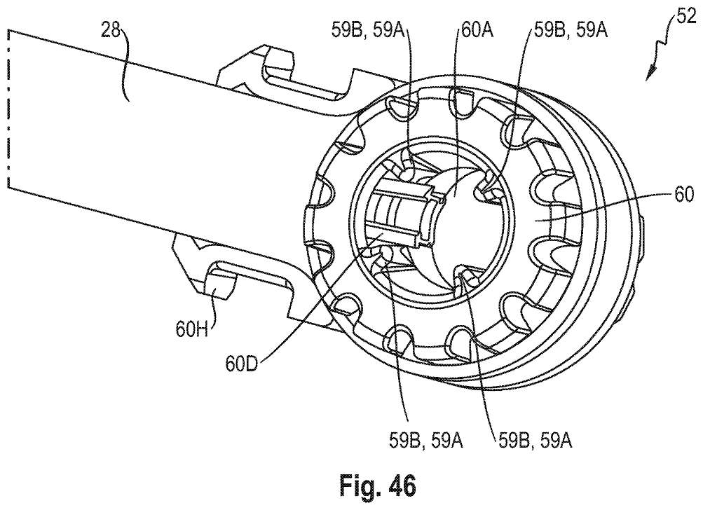

FIG. 46 is a perspective bottom view of the joint bearing as shown in FIG. 45;

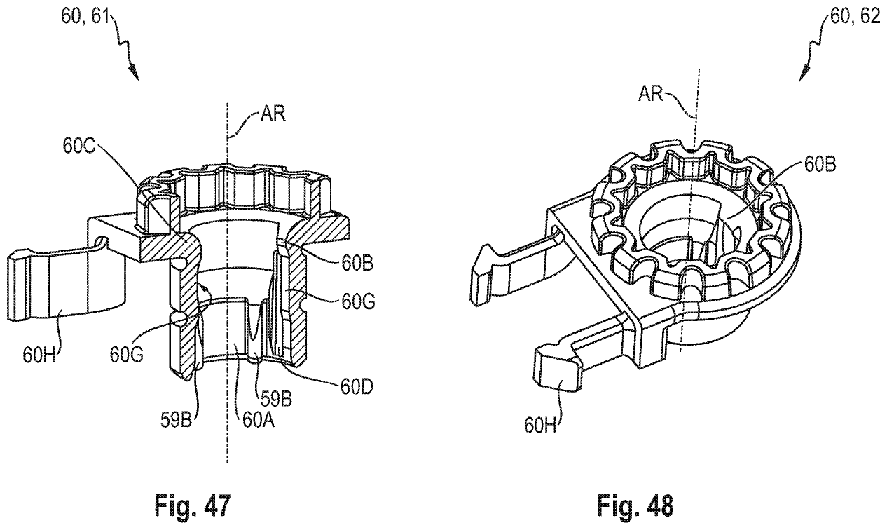

FIG. 47 is a perspective sectional view of the first joint bearing insert element of the joint insert for the joint bearing as shown in FIG. 46;

FIG. 48 is a perspective sectional view of the second joint bearing insert element of the joint insert for the joint bearing as shown in FIG. 46;

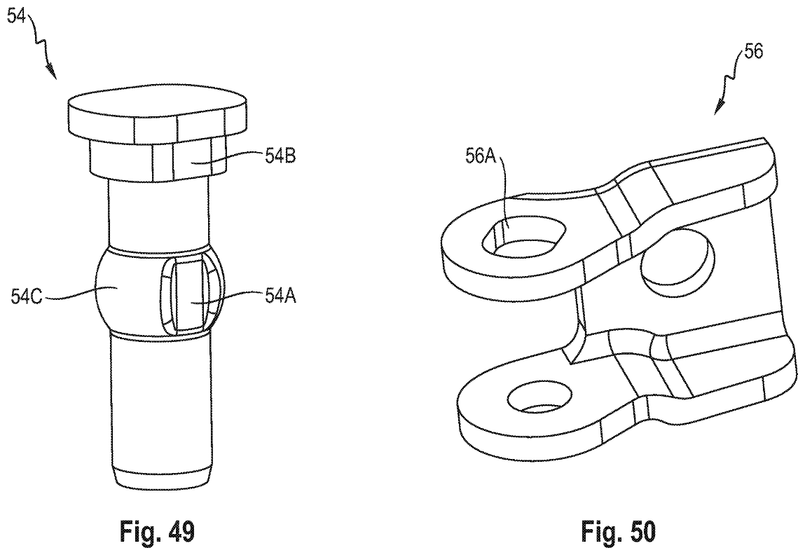

FIG. 49 shows a joint bolt for a joint bearing according to a preferred exemplary embodiment;

FIG. 50 shows a retaining plate for fastening the adjusting device to a vehicle;

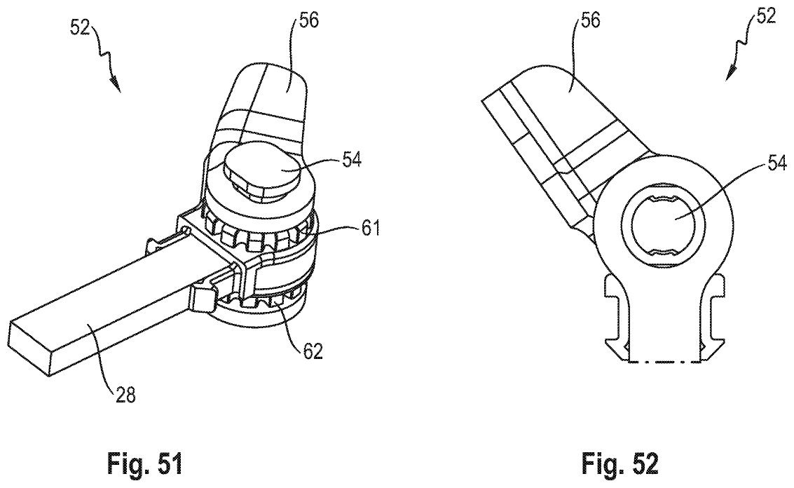

FIG. 51 shows an assembly of the adjusting element with a retaining plate, a joint bolt passing through the retaining plate and the joint bearing so that a pivot bearing connection is formed;

FIG. 52 is a sectional view of the assembly as shown in FIG. 51;

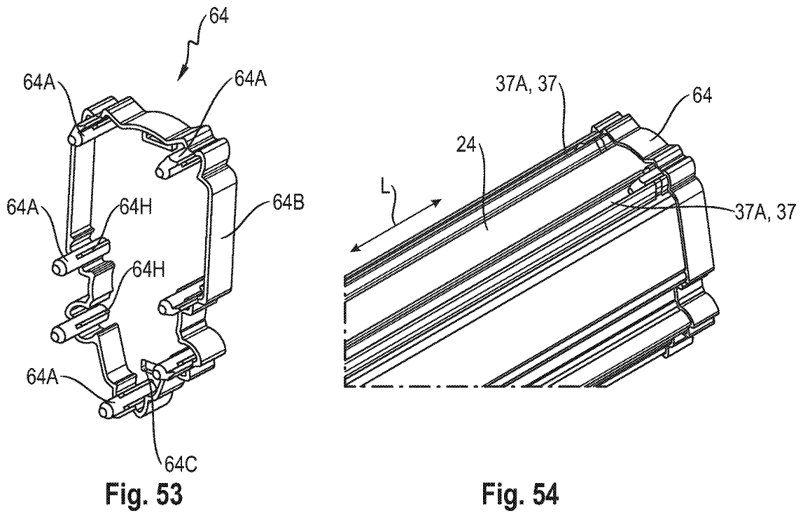

FIG. 53 is a perspective rear view of a cover of the housing of an adjusting device according to a preferred exemplary embodiment;

FIG. 54 is a perspective side view of an end of the housing of the adjusting device closed with the cover as shown in FIG. 53;

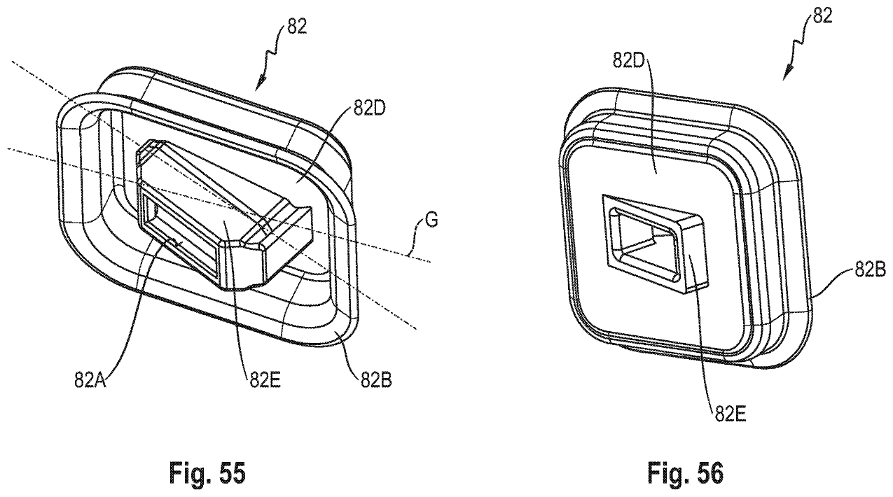

FIG. 55 is a perspective rear view of a sealing element of the adjusting device according to the invention according to a preferred exemplary embodiment;

FIG. 56 is a perspective front view of a sealing element according to a further, preferred exemplary embodiment;

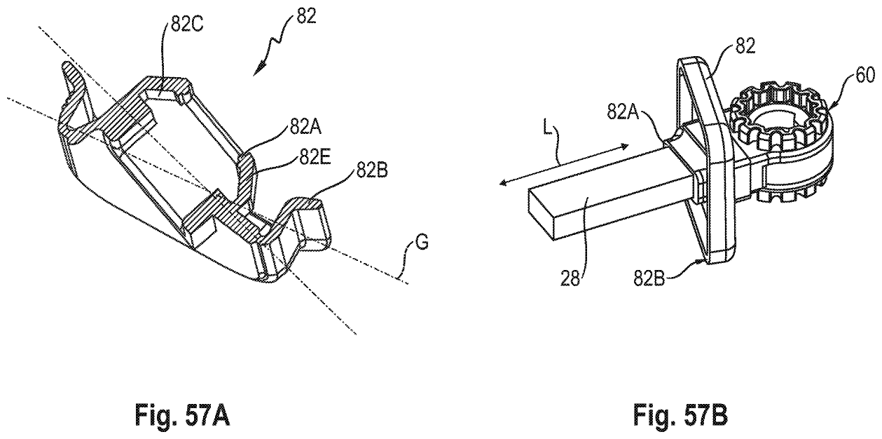

FIG. 57A is a perspective sectional view through the sealing element as shown in FIG. 55;

FIG. 57B is a perspective side view of an adjusting element with the sealing element arranged thereon;

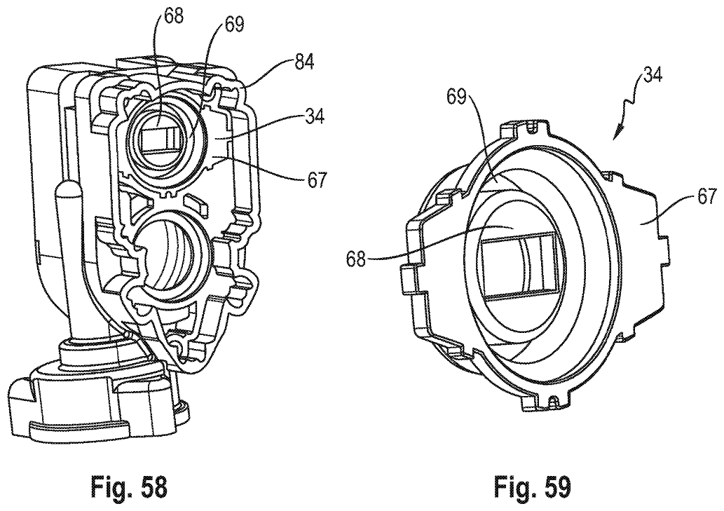

FIG. 58 is a perspective front view of the housing of an adjusting device according to the invention according to a preferred exemplary embodiment with a sealing arrangement inserted therein;

FIG. 59 is a perspective view of the sealing arrangement of FIG. 58;

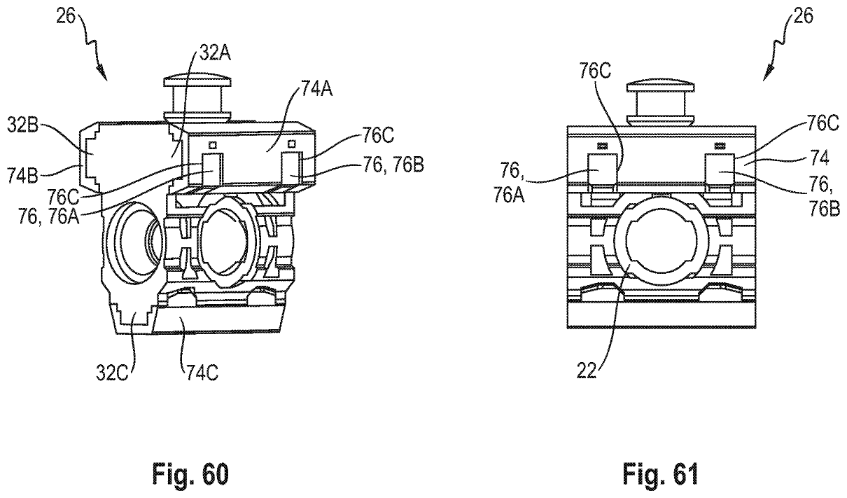

FIG. 60 is a perspective front view of the slide assembly of the adjusting device according to the invention according to a further, preferred exemplary embodiment with compensating elements for tolerance compensation; and

FIG. 61 is a side view of the slide assembly as shown in FIG. 60.

In FIG. 1, an adjusting device according to the invention is generally denoted by reference sign 10. The adjusting device 10 comprises a drive assembly 12 with a drive unit 14 and a drive element 16 driven by the drive unit 14. The drive element 16, which is designed here as a worm which is rotationally driven by the drive unit 14 designed as an electric motor, meshes with a worm wheel 18. The worm wheel 18 is fixedly arranged on a spindle 20 so that rotation of the drive element 16 causes rotation of the worm wheel 18 and thus of the spindle 20. The drive element 16 can be formed in one piece with a motor shaft 42 of the drive unit or, alternatively, can be connected thereto.

The spindle 20 is in threaded engagement with a spindle nut 22, wherein the spindle nut 22 is arranged in a rotationally secured manner relative to a housing 24 of the adjusting device 10 and is thus displaceable axially along a rotational axis R of the spindle 20 upon rotation of the spindle 20.

In the shown embodiment of the adjusting device 10, the spindle nut 22 is part of a slide assembly 26, which, together with the spindle nut 22, can be displaced along the rotational axis R of the spindle 20 upon rotation of the spindle 20. On an upper side of the slide assembly 26 in FIG. 1, said slide assembly is connected to an adjusting element 28, which is designed here as a straight door check strap. Alternatively, the adjusting element 28 could also be S-shaped, wherein this S-shape can extend substantially in a plane aligned parallel to the rotational axis R of the spindle 20 and orthogonally to the drawing plane of FIG. 1. In the embodiment shown, the adjusting element 28 has a round cross section. Alternatively, it may also be rectangular or approximately oval.

The adjusting element 28 is connected at its free end (shown on the left in FIG. 1) to a movable vehicle part, such as a side door of a vehicle (not shown), or alternatively to a vehicle body (not shown). At its end opposite the free end, the adjusting element 28 is connected to the slide assembly 26 via a pivot axis 30 in such a way that a movement of the adjusting element 28 out of the drawing plane of FIG. 1 about the pivot axis 30 or about the imaginary rotational axis S is possible.

Upon activation of the drive unit 14, the spindle 20 is thus set in rotation, whereby the adjusting element 28 is displaced via the slide assembly 26 along a displacement axis V, which in the neutral position (shown in FIG. 1) of the adjusting element 28 and the slide assembly 26 (see further below) coincides with a central axis of the straight adjusting element 28.

In order to also allow a certain movement of the free end of the adjusting element in an up and down direction in FIG. 1, the part of the slide assembly 26 to which the adjusting element 28 is connected is arranged in the shown exemplary embodiment so as to be tiltable relative to the spindle nut 22. For this purpose, the longitudinal ends of the spindle nut 22 can be provided with a curvature which corresponds to the curvature of a circle whose center coincides with a center of the longitudinal extent of the spindle nut 22 and the rotational axis R of the spindle 20 and which has a radius which corresponds to the distance of the center of the circle to a longitudinal end of the spindle nut 22. The surfaces of the remaining slide assembly 26 that are in contact with the spindle nut 22 may be curved analogously.

The slide assembly 26 can comprise at least one guide portion 32 in the region of the spindle nut 22 and/or on a portion separate therefrom, via which guide portion the slide assembly 26 is guided in the housing 24 of the adjusting device 10. In the exemplary embodiment shown in FIG. 1, the slide assembly 26 comprises a corresponding guide portion 22 both in the region of the spindle nut 22 and on a further portion. For reasons of symmetrical force distribution, these two guide portions can also be present on the opposite side (not visible in FIG. 1) of the slide assembly 26.

In order to protect the interior of the adjusting device 10 from contamination, the adjusting device 10 in the exemplary embodiment shown comprises a sealing arrangement 34, which is arranged between the adjusting element 28 and the housing 24.

In general, however, the adjusting device 10 can also be designed without a sealing arrangement 34. In this case, it may be advantageous for the housing 24, for example, to be provided with at least one drain hole so that moisture that has entered the housing 24 can escape.

FIG. 2 shows the adjusting device 10 according to the invention of FIG. 1 in a side view. It can be seen that the central axis M of the drive element 16 is arranged at an angle to a plane that is defined by the displacement axis V of the adjusting element 28 (in the neutral position of the adjusting element 28 and the slide assembly 26 as shown in FIG. 1) and the rotational axis R of the spindle 20. As can be seen in particular in FIG. 2, a lower portion of the drive assembly 12 in FIG. 2 can thus be displaced into a region vertically below the spindle 20. The required installation space can thus be reduced, in particular the installation space that is located to the right of the drive assembly 12 in FIG. 2.

Furthermore, the design according to the invention of the adjusting device 10 allows a movable attachment of the housing 24 of the adjusting device 10 to the vehicle body or to the movable vehicle part to be converted into a rigid fastening, whereby additional space requirements can be eliminated.

The adjusting device 10 shown is in particular intended for mounting on the movable vehicle part. In the exemplary embodiment shown, the drive assembly 12 is arranged on a front side of the adjusting device 10, wherein the front side is understood to be a side of the adjusting device 10 facing the free end of the adjusting element 28. However, due to the limited installation space on the movable vehicle part, it may be advantageous to provide a reverse arrangement of the drive assembly 12. In other words, it may be advantageous due to installation space constraints to arrange the drive assembly 12 on a rear side of the adjusting device 10 facing away from the free end of the adjusting element 28. In this case, an angled arrangement of the central axis M of the drive element 16 as shown in FIG. 2 can be omitted and a more compact design can be achieved. A further advantage of this reverse arrangement of the drive assembly 12 is the resulting possibility of designing the adjusting device 10 in a simple manner in the same construction for both sides of the vehicle, i.e., for the left and the right vehicle sides. It is only necessary to tilt the assembly by 180°.

The basic structure and function of these two embodiments, which differ in the arrangement of the drive unit 12, are basically identical.

In order to ensure that, even in the installed state, the adjusting device 10 can be clearly identified, for example by a workshop employee, without having to remove it from the vehicle or the side door, a suitable marking of the adjusting device 10 is provided. However, since these markings should not be visible to an end customer/driver of the vehicle, the adjusting element 28 can advantageously be labeled on a side wall that, in the installed state, faces away from the passenger compartment of the vehicle. In the installed state, this side wall of the adjusting device 28 faces, for example, the side door and is not visible to an end customer of the vehicle. If the adjusting device 10 is arranged, tilted by 180°, on the other vehicle side, the marking is also located on the side wall of the adjusting element 28 that faces away from the passenger compartment.

As a further advantageous labeling method, it is conceivable to label the adjusting element 28 by means of a suitable lacquer, which can only be made visible when using a suitable light source. For example, a UV varnish can be used, which only becomes visible with the aid of a UV lamp.

FIG. 3 shows a housing 24 of a further exemplary embodiment of an adjusting device 10 according to the invention, which substantially corresponds to the adjusting device 10 described above. The housing 24 of this embodiment is a section tube, preferably made of aluminum, with an open profile structure and with longitudinal notches or longitudinal grooves 37 at least at corner points 35. In order to create an additional fastening point for the adjusting device 10 in a simple manner, a fastening element 36 adapted to the section tube is provided, which fastening element is fastened to the housing 24 by means of a frictional and/or positive connection. The fastening element 36 can be fastened, for example, by a rivet 33 or a screw. As can be seen in FIG. 4, which shows a cross section of the housing 24 with the fastening element 36, the fastening element 36 has a plate-shaped sub-element on or to which a fastening bolt 31 is formed or fastened. The plate-shaped sub-element and the fastening bolt 31 extend in an orthogonal direction relative to a longitudinal axis of the adjusting element 10. An arm-shaped sub-element of the fastening element 36 encompasses a top side of the housing 24, wherein the fastening element 36 engages in three of the longitudinal grooves 37 and is fastened in one of the longitudinal grooves 37 as described above. The fastening element 36 allows for an additional fastening point that can be flexibly adapted to the installation space.

FIGS. 5 and 6 show a slide assembly 26 with an articulated adjusting element 28 of a further exemplary embodiment of an adjusting device 10 according to the invention, which substantially corresponds to the adjusting device 10 described above.

The adjusting element 28 is connected to the slide assembly 26 by means of a ball joint connection, wherein the ball joint connection comprises a ball bolt 38 immovably connected to the adjusting element 28 and a ball socket 40 formed in the slide assembly 26. As can be seen in FIG. 6, the ball socket 40 is provided in one piece with the slide assembly 26, which is preferably made of a plastics material. The ball bolt, which is preferably provided as a cold-formed part, can be connected to the adjusting element, which can be provided as a stamped part, by means of reshaping processes, preferably riveting, in a positive manner or in a positive and non-positive manner. For easy fastening of the ball bolt 38, pin-shaped fastening elements (not shown) can be provided, which penetrate the slide assembly 26 and fix a ball head of the ball bolt 38 in the ball socket 40 so that it can rotate with as little play as possible. For this purpose, the slide assembly 26 has through-bores 39, which are visible in FIG. 6, for example.

FIG. 7 shows a detail of a side cross section of a further exemplary embodiment of an adjusting device 10 according to the invention, which substantially corresponds to the adjusting device 10 described above.

In this exemplary embodiment, the drive unit 14 is also an electric motor, the motor shaft 42 or the drive unit 16 of which is mounted in an axially preloaded manner in a drive housing 84 connected to the housing 24. At this point, it should be mentioned that the drive housing 84 is to be regarded as part of the housing 24 and may be formed in one piece therewith. The motor shaft 42, which is formed here in one piece with the drive element 16, rests against an axial motor shaft preload assembly. The assembly shown in FIGS. 8 to 10 comprises a plastics element 46 with a spherical-segment-shaped, convex, concave or flat contact surface for the motor shaft 42; a screw 48, which can be screwed into the drive housing 84, rests against the plastics element 46 and is connected thereto in a captive manner by means of two undercuts 41; and a spring element 50, which is arranged or encapsulated between the plastics element 46 and the screw 48.

On the one hand, axial preloading, i.e., screwing in the screw 48, can reduce chain tolerances of the individual components so that it is possible to prevent or minimize the resulting noise. On the other hand, the encapsulated spring element 50 allows temperature compensation so that a constant preload force on the motor shaft 42 and thus quiet running of the motor are possible across all temperatures.

FIGS. 11 to 13 show a slide assembly 26 with a spindle nut 22 arranged thereon, of a further exemplary embodiment of an adjusting device 10 according to the invention, which substantially corresponds to the adjusting device 10 described above.

As can be seen in FIGS. 11 to 13, the spindle nut 22 of the exemplary embodiment has, in cross section, two different outer circumferences 43, 45 with a common center M, wherein the spindle nut 22 can be tilted in the slide assembly 26, wherein a torsional moment can be supported at the same time. A first outer circumference 43 is provided to be larger than a second outer circumference 45. An inner contour 47 of the slide assembly 26 is adapted thereto and has analogous inner surfaces. Transition surfaces 49 between the outer circumferences 43 and 45 also allow the tilting movement to be limited. In particular, if the adjusting device 10 is not handled correctly, damage to the spindle drive must be excluded. It is therefore necessary to arrange the spindle nut 22 in the slide assembly 26 in a tiltable manner, wherein the tilting function must not have any negative effects on the required torque absorption for the function in the slide assembly 26. Due to the different outer circumferences 43, 45 of the spindle nut and the inner contour 47 of the slide assembly 26 adapted thereto, the support of the torque via the second outer circumference 45 of the spindle nut 22 can be ensured despite the tilting function.

FIGS. 14 to 18 show, in a spatial or sectional representation, multiple further embodiments of an adjusting device 10 according to the invention, which substantially corresponds to the adjusting device 10 described above.

At its end facing away from the slide assembly 26, the adjusting element 28 (only shown in part) has a joint bearing 52 with a joint bearing insert 60, wherein the joint bearing 52 is connected to a retaining plate 56 by means of a joint bolt 54 shown in FIG. 15. The exemplary embodiments as shown in FIGS. 14 to 18 have in common that the joint bearing 52 in each case has means for compensating for angular errors in the fastening of a retaining plate.

For fastening, the retaining plate 56 (also called angle plate) is fastened to the vehicle (vehicle door or body). Twisted fastening of the retaining plate 56 affects the coordinated movement geometries and leads to a misalignment of the system. In order to avoid complex mounting of the retaining plate 56 by means of a template, angular errors in the region of the joint bearing 52 can be compensated according to the invention so that this error does not have any further effect on the subsequent system.

FIGS. 14 and 15 show a further exemplary embodiment. The joint bearing 52 of the adjusting element 28 has the joint bearing insert 60, which is manufactured by overmolding or welding of the joint bearing 52 in this exemplary embodiment. As can be seen from the figures, on the top and the bottom side, the joint bearing insert 60 has a crush rib 58 with a comb structure, which allows angular errors to be compensated in the axial direction. Compensation is achieved by deformation of the crush rib 58 in the event the retaining plate 56 is screwed on incorrectly. Prior thereto, the comb structure stabilizes the system so that the angle plate 56 cannot twist arbitrarily when it is screwed on, without the need to use a template.

FIG. 16 shows a further exemplary embodiment, which, in contrast to the preceding exemplary embodiment, has a wave-shaped wear or centering contour 59 on the bottom side of the joint bearing insert 60, which contour allows angular errors to be compensated in the radial direction. Compensation is achieved by wearing of the contour in the event the retaining plate 56 is screwed on incorrectly. A detailed description of the centering contour 59 can be found in the below-described exemplary embodiments as shown in FIGS. 42 to 47.

According to the further exemplary embodiments shown in FIGS. 17 and 18, the joint bearing insert 60 can be formed in two parts and comprise a first joint bearing insert element 61 and a second joint bearing insert element 62. The first joint bearing insert element 61 and the second joint bearing insert element 62 can, for example, be connected in a firmly bonded or positive manner. FIG. 17 shows a screw connection between the joint bearing insert elements 61, 62. This connection has the advantage that it is independent of the thickness of the joint bearing 52 of the adjusting element 28.

In contrast, FIG. 18 shows a bayonet connection between the joint bearing insert elements 61, 62.

Alternatively, a firmly bonded connection of the joint bearing insert elements 61, 62 is possible, in which case, for example, ultrasonic welding can be used to connect the two joint bearing insert elements 61, 62.

As already described for the exemplary embodiment as shown in FIG. 3, the housing 24 can be a section tube which is closed by means of a cover 64 on the side facing away from the drive assembly 12.

According to a further exemplary embodiment of the invention shown in FIGS. 19 to 21, the cover 64 can be fixed to the section tube without additional components. For this purpose, the cover 64 made of plastics material has molded domes 66, which engage in the longitudinal notches/longitudinal grooves 37 at the corner points 35 or side surfaces of the housing 24 and are fixed therein by reshaping of the housing 24. The cover 64 has at least three, preferably seven domes 66.

The reshaping of the housing 24 can be seen in FIG. 20, which shows an enlarged detail of the housing 24 in the region of a longitudinal groove 37. Reshaping is carried out, for example, by a pin with which the material of the longitudinal groove 37 is deformed in the direction of the dome 66 so that the dome 66 is fixed to the housing 24 in a captive manner.

A further exemplary embodiment of the invention as shown in FIGS. 22 and 23 shows a sealing arrangement 34 of an adjusting device 10 according to the invention, which substantially corresponds to the adjusting device 10 described above. The adjusting element 28 usually has a rectangular cross section and protrudes from the housing in a sealed manner by means of the sealing arrangement 34. The sealing arrangement 34 is advantageously designed as a bellows sleeve combined with a rod wiper and has a fastening portion 67, a wiper portion 69 arranged axially movably on the adjusting element 28, and a bellows portion 68 located between them. The fastening portion 67 is clamped between the housing 24 and the drive housing 84 connected thereto, and the wiper portion 69 rests sealingly with an opening 78 adapted to the cross section of the adjusting element 28, against said adjusting element.

The bellows portion 68 of the sealing arrangement 34 is configured to be able to follow the pivoting and tilting movements as well as pendulum movements of the adjusting element 28 and to ensure axial stability for the wiping effect.

FIG. 24 shows a side cross-sectional view of a further exemplary embodiment of an adjusting device according to the invention, wherein the slide assembly 26 is shown in the two end positions.

As already described above, the housing 24 is also a section tube and is closed by means of a cover 64 on the side facing away from the drive assembly 12. The cover 64 shown here additionally has a drainage opening 70, which can be sealed by means of a piston geometry 72 arranged on the slide assembly 26, in an end position of the slide assembly 26 facing the cover 64. Despite existing sealing measures, it cannot be ruled out that water will enter the adjusting device 10 in the region of the adjusting element 28. It is therefore advantageous if the water that has penetrated can be drained out of the adjusting device 10 via the drainage opening 70 when the vehicle door is opened. The piston geometry 72 arranged on the slide assembly 26 seals the drainage opening 70 when the vehicle door is closed. For this purpose, the piston geometry 72 has a radial seal, which, in the end position, seals the drainage opening 70 or a projection 71 molded on the cover 64.

A further advantageous exemplary embodiment of an adjusting device 10 according to the invention, which substantially corresponds to the adjusting device 10 described above, is shown in FIGS. 25 and 26. The slide assembly 26 shown in FIG. 25 has at least a first and a second guide portion 32 (32A, 32B) for guidance in the housing 24, wherein a guide rail 74 is fixed to the guide portion 32 substantially without play in each case. Optionally, a third guide portion 32C may be provided on the slide assembly 26.

The housing 24 has prismatic sliding or guide surfaces 77 for guiding the slide assembly 26, wherein corresponding prismatic sliding or guide surfaces 75 are formed on each guide rail 74, which is pressed onto the guide portion 32 without play, for example.

In order to allow the sliding surfaces 75 to be guided on the guide surfaces 77 of the housing 24 with as little play as possible, at least one of the two guide rails 74 has means for self-adjusting play reduction.

The self-adjusting play reduction between the slide assembly 26 and the housing 24 can be achieved, for example, by spring-loaded adjusting elements 76 which are mounted perpendicularly to the displacement direction of the slide assembly 26. Spring elements 80 used for this purpose can be adapted to the application and the load case without structural changes to the slide assembly or the guide.

This arrangement makes it possible to produce a virtually play-free linear guide of the slide assembly 26 as well as a defined, constant frictional torque between the slide assembly 26 and the housing 24.

In other words, it is possible to produce a virtually play-free linear guide of the slide assembly 26 as well as a defined, constant frictional torque between the slide assembly 26 and the housing 24 so that a necessary holding force, for example of a vehicle door, can be fully or partially achieved. A further advantage of applying friction at this point of action of the adjusting device 10 is a uniform basic load, which leads to quieter running of the entire system.

According to a further embodiment not shown, the guide rails 74 can also be molded onto the slide assembly 26 by means of a two-component injection-molding process.

When using a suitable material, it is also conceivable to form the slide assembly 26 in one piece with the guide rails 74.

FIG. 27 shows a housing 24 of an adjusting device 10 according to the invention according to a further, preferred exemplary embodiment. The housing 24 is preferably formed as an extruded profile made of aluminum. The housing 24 has receptacles 37A in the form of longitudinal grooves 37, which can be formed integrally with the extruded profile. The receptacles 37A or the longitudinal grooves 37 are arranged distributed over the housing 24 and are preferably aligned symmetrically to one another with respect to a vertical central plane of the housing 24. In particular, the longitudinal grooves 37 run parallel to one another. A fastening element 36 is provided for fastening the adjusting device 10 to a vehicle, for example a vehicle part that is movable relative to a body of a vehicle, or for fastening to the body of the vehicle itself. The fastening element 36 is designed substantially analogously to the fastening element as shown in FIG. 3 and is likewise used as an additional fastening point for the adjusting device 10. Specifically, the fastening element 36 has a guide device 37B, which has multiple guide elements 37C, 37D, 37E. Substantially, the guide elements 37C, 37D, 37E are pin-shaped and extend beyond end surfaces of the fastening element 36. The guide elements 37C, 37D, 37E have an outer contour, which substantially corresponds to the inner contour of the longitudinal grooves 37 so that the guide elements 37C, 37D, 37E can be guided in the longitudinal grooves 37 in a slide-like manner. The fastening element 36 can be inserted into the longitudinal grooves 37 or, generally, the receptacle 37A and can be moved along the receptacle 37A and the longitudinal grooves 37. The fastening element 36 can thus be displaced along the housing 24.

FIG. 27A shows a further perspective view of a housing 24 of an adjusting device 10 according to the invention according to an additional embodiment. The housing 24 is formed as an extruded profile made of aluminum and has the receptacle 37A in the form of longitudinal grooves 37. The fastening element 36 comprises the guide device 37B and multiple guide elements 37C, 37D, 37E. In addition, the fastening element 36 comprises a holding means 371 for cables. The holding means 371 provides an opening for inserting a cable clip. A cable clip usually has evergreen-like locking means, which can be inserted into the opening, allowing a cable holder of the cable clip to carry one or more cables.

As can be clearly seen in FIGS. 28A and 28B, embodiments of the fastening element 36 comprise an arm-shaped sub-element 36C, which extends over an upper side of the housing 24 (FIG. 27). At a free end, the arm-like sub-element 36C has a first guide element 37C of the guide device 37B. The arm-shaped sub-element 36C is used as a connecting element between the guide elements 37D and 37C to absorb larger force loads. In the region of the transition between a trapezoidal sub-element 36D of the fastening element 36 and the arm-shaped sub-element 36C, a second guide element 37D is arranged on a side facing the housing 24. Likewise, a third guide element 37E is provided at an end of the trapezoidal sub-element 36D opposite the arm-shaped sub-element 36C. Overall, the fastening element 36 thus has three guide elements 37C, 37D, 37E, which together form the guide device 37B.

The guide elements 37C, 37D, 37E are substantially pin-like with a substantially cylindrical outer contour. Each guide element 37B comprises a first end 37F and a second end 37G. The first end 37F and the second end 37G preferably have a conical taper. Specifically, the first ends 37F and the second ends 37G are each frustoconical. The taper formed there makes it possible to easily insert the guide elements 37C, 37D, 37E into the longitudinal grooves 37 during assembly.

In order to achieve lateral stabilization of the guide elements 37C, 37D, 37E in the longitudinal grooves 37, preloading elements 37H in the form of ribs are preferably provided on the guide elements 37C, 37D, 37E and extend at least in portions along the corresponding guide elements 37C, 37D, 37E. The preloading elements 37H run parallel to a longitudinal axis of the guide elements 37C, 37D, 37E. As can be seen in FIG. 28B, a further preloading element 37H in the form of a rib can be provided on a rear surface of the trapezoidal sub-element 36D. The rib on the trapezoidal sub-element 36D preferably rests against a planar outer surface of the housing 24 and is thus used as a tolerance compensation or preloading element relative to the housing 24 so that rattling noises due to mechanical play during vehicle operation can be excluded. For connecting the fastening element 36 to a vehicle part and/or a vehicle body, a threaded portion 36A is formed in the trapezoidal sub-element 36D. The threaded portion 36A comprises an internal thread, which can cooperate with a screw, for example. In order to facilitate the insertion of the screw into the threaded portion 36A, a funnel-shaped feed 36B opens into the threaded portion 36A.

The two fastening elements 36 as shown in FIGS. 28A and 28B are substantially analogous to one another. However, the fastening elements 36 may differ from one another in details. For example, the arm-shaped sub-element 36C of the fastening element 36 as shown in FIG. 28A has a substantially outward-curved, i.e., concave, curvature. In the exemplary embodiment of the fastening element 36 as shown in FIG. 28B, however, the arm-shaped sub-element 36C is curved inward in portions. The fastening element 36 as shown in FIG. 28B is shown, for example, in the combination with the housing 24 in FIG. 27. FIG. 30 also shows the fastening element 36 as shown in FIG. 28B in a further perspective view.

FIG. 29 shows the fastening element 36 as shown in FIG. 28A in a cross-sectional view. Specifically, FIG. 29 shows again that the guide elements 37C, 37D, 37E can be arranged at different locations on the fastening element 36. For the sake of clarity, a guide element arranged on the free longitudinal end of the arm-shaped sub-element 36C is referred to as the first guide element 37C. A guide element arranged in the transition portion between the arm-shaped sub-element 36C and the trapezoidal sub-element 36D is referred to as the second guide element 37D. The third guide element 37E is a guide element located at an end of the trapezoidal sub-element 36D opposite the arm-shaped sub-element 36C. The arrangement of the first guide element 37C, the second guide element 37D, and the third guide element 37E shown in connection with the fastening element 36 as shown in FIG. 29 also applies analogously to the exemplary embodiment of a fastening element 36 as shown in FIGS. 28B and 30.

FIG. 31 shows the slide assembly 26, to which the adjusting element 28 is articulated. The articulated connection between the adjusting element 28 and the slide assembly 26 is preferably made via a ball bolt 38. Via the ball bolt 38, the adjusting element 28 is coupled in particular to a top side of the slide assembly 26. Specifically, the ball bolt 38 engages in the region of the guide portions 32A, 32B of the slide assembly 26.

The design of the ball bolt 38 is clearly visible in the sectional view of FIG. 32. The ball bolt 38 is preferably fixedly, in particular also rotationally fixedly, connected to the adjusting element 28. The ball bolt 38 passes through a through-opening in the adjusting element 28 and is axially secured therein in a positive manner relative to the bore axis. The ball bolt 38 can be secured against rotation with respect to the adjusting element 28 either by a frictional connection and/or by a positive connection, for example by welding. At a lower end, the ball bolt 38 forms a partially spherical outer contour. This partially spherical outer contour engages in a corresponding ball socket 40 in the slide assembly 26. The ball bolt 38 is preferably mounted positively but movably in the ball socket 40. This mounting allows the adjusting element 28 to be both pivotable and tiltable with respect to the slide assembly 26. This mobility is advantageous in order that tensions that could arise due to the movement of the adjusting element 28 are compensated so that quiet movement of the adjusting device is ensured.

FIGS. 32A, 32B, and 32C show different variants of the fastening of the ball bolt 38 to the adjusting element 28. The adjusting element 28 with the ball bolt 38 is shown in a horizontal sectional view in each case. The horizontal section runs substantially through a longitudinal central axis of the adjusting element 28 and centrally through the through-bore through which the ball bolt 38 passes.

In the exemplary embodiment as shown in FIG. 32A, the through-bore in the adjusting element 28 has a circular inner circumferential surface through which the ball bolt 38 passes. The ball bolt 38 also has a circular outer circumferential surface in this region. The ball bolt 38 can thus be arranged, mounted in a rotationally sliding manner, on the adjusting element 28 so that rotation between the adjusting element 28 and the ball bolt 38 is possible. Alternatively, it is possible to create a firmly bonded connection that prevents rotation. For example, the ball bolt 38 can be welded to the adjusting element 28.

In the exemplary embodiment as shown in FIG. 32B, however, rotation is prevented by a mechanically provided rotation prevention mechanism 39A. The rotation prevention mechanism 39A preferably comprises a toothed outer contour of a fastening portion of the ball bolt 38, which forms a press-fit connection with the inner contour of the through-bore in the adjusting element 28. Alternatively, the adjusting element 28 can also have a knurled or toothed inner contour so that the knurling or toothing of the ball bolt 38 cooperates with the knurling or toothing of the adjusting element 28 and thus forms the rotation prevention mechanism 39A.

Another possibility for the rotation prevention mechanism as shown in FIG. 32A is to provide a minimal clearance fit between the ball bolt 38 and the adjusting element 28. In the original state, the ball bolt 38 preferably has a cylindrical extension, which extends from the partially spherical portion of the ball bolt 38 and is inserted through the opening of the adjusting element 28. Subsequently, the cylindrical portion of the ball bolt 38 is reshaped, thus forming a riveting, which, on the one hand, leads to a positive fixing of the ball bolt 38 along the bore axis and, on the other hand, the compression causes an increase in the diameter of the ball bolt 38 so that the cylindrical portion of the ball bolt 38 is pressed radially into the bore of the adjusting element 28.

The exemplary embodiment as shown in FIG. 32C shows a ball bolt 38, which has a trilobular contour in the region of the adjusting element 28. The cross-sectional geometry of the portion of the ball bolt 38 extending from the partially spherical portion thus substantially corresponds to a rounded triangle. This contour can be easily pressed into the adjusting element 28 and offers a rotation prevention mechanism due to the trilobular contour 39B.

As an alternative to the variants shown in FIGS. 32A, 32B, and 32C, it is also possible for the ball bolt 38 and the adjusting element 28 to be formed in one piece or monolithically.

FIG. 33 shows the ball socket 40, which is formed in the slide assembly 26, specifically in the region of the guide portions 32A, 32B of the slide assembly 26. The ball socket 40 is formed in one piece with the slide assembly 26. At least one pocket 40A designed to receive lubricant may be provided in the ball socket 40. Specifically, the ball socket 40 preferably has multiple pockets 40A, which are substantially introduced as notches into the ball socket 40. Furthermore, the ball socket 40 may have at least two lateral bearing tabs 40B, against which the ball bolt 38 can rest. Preferably, the bearing tabs 40 are each delimited by two pockets 40A. The bearing tabs 40B are arranged at least in a lower portion 40C of the ball socket 40 (FIG. 34).

In FIG. 34, the arrangement of the ball bolt 38 in the ball socket 40 is clearly visible. It can be seen that the spherical portion of the ball bolt 38 engages in the ball socket 40. The pockets 40A, which are each arranged between the at least two lateral bearing tabs 40B, make it possible to receive lubricant so that the ball connection provided by the ball bolts 38 and the ball socket 40 is well lubricated and permanently mounted without wear.

In order to hold the ball bolt 38 in the ball socket 40, at least one fastening element 39C is preferably provided, which secures the ball bolt 38 inserted into the ball socket 40. The fastening element 39C is preferably made of metal, in particular steel. The fastening element 39C can be designed such that it at least partially penetrates the slide assembly 26 and the ball socket 40. Specifically, two parallel fastening pins or bolts, which secure the ball bolt 38 in the ball socket 40, can be provided as the fastening element 39C. The fastening pins can be inserted laterally into the first guide portion 32A of the slide assembly 26 and can come into contact with the ball bolt 38 in a transition region between the spherical portion of the ball bolt 38 and the connecting portion to the adjusting element 28. As can be clearly seen in FIG. 34, the fastening elements 39C thus prevent the ball bolt 38 from leaving the ball socket 40.

FIG. 34A to 34D show a further embodiment of an arrangement of the ball bolt 38 in the ball socket 40. According to this alternative embodiment, the ball socket 40 may have a surface comprising a lubricious plastics material. For example, it is conceivable to provide a separate ball head receptacle 40D made of a lubricious plastics material. This ball head receptacle 40D may have flexible elements 40F for improved mounting and securing of the ball bolt 38 in the ball head receptacle 40D and in the ball socket 40 and can absorb compressive and tensile forces acting on the ball bolt 38. For secure fastening of the ball head receptacle 40D in the slide assembly 26, locking means 40E can, for example, be provided, which can be locked into suitable undercuts 40G of the slide assembly 26. Alternatively or additionally, the fastening element 39C used in the above embodiment, here two fastening pins, can be inserted.

In the shown embodiment, the ball head receptacle 40D encloses the metal, preferably steel, ball head of the ball bolt 38 with the flexible elements 40F. The flexible elements 40F are arm-shaped. As can be seen in FIG. 34C, the fastening pins pass through the slide assembly 26 in such a way that the ball head is prevented from escaping from the ball head receptacle 40D. The fastening pins rest against corresponding cutouts 39D of the flexible elements 40F so that a type of sandwich structure (steel-plastic-steel) is advantageously created, in which the plastics material of the ball head receptacle 40D only experiences a compressive load. This connection allows a play-free or virtually play-free arrangement of the ball bolt 38 in the slide assembly 26 and at the same time has very low wear. The fastening pins are positioned parallel to one another, wherein the distance between the facing inner edges of the fastening pins is smaller than a maximum ball diameter of the ball head. Thus, even if the plastics material of the ball head receptacle 40D fails, the ball head can be securely held in the slide assembly 26 because a steel-to-steel connection is formed.

FIG. 34D shows the arrangement of two fastening pins aligned parallel to one another. The fastening pins are arranged in the cutouts 39D on the ball head receptacle 40D. The cutouts 39D are located on the top side of the flexible elements 40F, wherein the ball head receptacle 40D encloses the ball head of a ball bolt 38.

In FIG. 35, the drive element 16, which is provided here in one piece with the motor shaft 42, is shown in section in its arrangement on or in the housing 24 or drive housing 84. It should be mentioned again that the drive housing 84 is to be regarded as part of the housing 24 and can optionally be formed in one piece therewith. The drive element 16 comprises a free end 16A, which extends from an end of a worm of the drive element 16 that meshes with the worm wheel 18. The drive element 16 is preferably axially preloaded via the axial end 16A in order to compensate for the high tolerances of the drive element 16 or the motor shaft. Specifically, the drive element 16 is thus mounted in an axially preloaded manner relative to the drive housing 84.

For this purpose, a plastics element 46 is preferably arranged between the free end 16A of the drive element 16 and the drive housing 84. The plastics element 46 is shown in detail in FIG. 36A. Specifically, the plastics element 46 can comprise an elastomer and thus function as an elastic damping element. The plastics element 46 is preferably received in a sleeve 46A, which is arranged between the free end 16A of the drive element 16 and the drive housing 84. The arrangement of the sleeve 46A between the drive housing 84 and the drive element 16 or the free end 16A thereof is clearly visible in FIG. 35. Furthermore, in FIG. 36B, the axial play of the drive element 16 or the motor shaft is symbolically represented by a double arrow. This axial play can vary greatly within a series due to manufacturing tolerances so that tolerance compensation is advantageous. The axial play is shown by the double arrow running parallel to the axial direction A of the drive element 16.

In the sectional view of FIG. 36C, the sleeve 46a is shown, which comprises a recess 46B on a side facing away from the drive element 16. The recess 46B is preferably annular, with the plastics element 46 being received in the recess. The depth of the recess 46B is dimensioned such that it is smaller than a diameter of the plastics element 46. In this way, the plastics element 46 protrudes in the axial direction A beyond an edge of the sleeve 46A. The depth of the recess 46B can be adjusted via ribs 46D, which protrude upward from the bottom of the recess 46B. The top side of the ribs 46D form a support 46C, which, together with the edge of the sleeve 46A, defines a depth of the recess 46B. This recess is preferably less than the diameter of the plastics element 46. The ribs 46D thus form the support 46C for the plastics element 46 in the recess 46B. The ribs 46D are arranged radially, as can be seen in FIG. 36D. The ribs 46D extend from a central extension 46E, which is provided for the centered clamping of the plastics element 46. The central extension 46E is substantially frustoconical in shape (FIG. 36C). Starting from the bottom 46C of the recess 46B, the central extension 46E tapers in the direction of the edge of the sleeve 46A. At the front end of the central extension 46E, there is an axial stop 47A, which defines the end stop of the axial play of the drive element A with respect to the drive housing 84 4.

With respect to the drive housing 84, the sleeve 46A is preferably arranged in a rotationally secure manner. For this purpose, a rotation prevention mechanism 46G can be provided on a lateral surface 46F of the sleeve 46A. The rotation prevention mechanism 46G can be designed to correspond to a corresponding stop in the drive housing 84. Specifically, the rotation prevention mechanism 46G can be shaped as a ridge or rib that positively engages in a corresponding notch in the drive housing 84. The axial preload between the drive housing 84 and the drive element 16 can also be achieved in an alternative manner. In general, a bearing space 16C is provided between the drive element 16, in particular the free end 16A thereof, and the drive housing 84. If the assembly of the sleeve 46A and the plastics element 46 is used as a preloading device, which achieves the axial preload of the drive element 16 with respect to the drive housing 84, the assembly of the sleeve 46A and the plastics element 46 is arranged in this bearing space 16C, which can be seen in particular in FIG. 37C of the exemplary embodiment described below.

In an alternative variant (FIG. 37A to 38), however, it is provided that the bearing space 16C is filled with a curable plastics material. The axial preload is thus achieved in that, after the drive element 16 has been inserted into the drive housing 84, a plastics material is introduced in a liquid state into the bearing space 16C and cured there. This compensates for tolerances between the drive element 16 and the drive housing 84. For this purpose, it is preferably provided that a bushing 16D is arranged on the free end 16A of the drive element 16. Such a bushing 16D is shown in FIG. 38. The bushing 16D has an axial mounting 16G, which is directly connected to the drive element 16. At a portion opposite the axial mounting 16G, the bushing 16D is equipped with tooth-like extensions 16E. Specifically, the tooth-like extensions 16E are arranged, pointing away from the drive element 16, in the direction of the bearing space 16C. In other words, the tooth-like extensions 16E protrude into the bearing space 16C. A sealing element 16F, for example an O-ring or a molded seal, is arranged between the tooth-like extensions 16E and the axial mounting 16G and extends circumferentially around the bushing 16D. On their outer circumference, the tooth-like extensions 16E and the axial mounting 16G preferably have multiple ribs, which secure the sealing element 16F in the axial direction.

The axial preload is achieved by means of the bushing 16D in that, after the bushing 16D has been inserted with the drive element 16 into the drive housing 84, the bearing space 16C is filled with a plastics material. The liquefied plastics material fills the bearing space 16C as well as the spaces between the tooth-like extensions 16E. Air can escape through the spaces between the tooth-like extensions 16E when filling with liquid plastics material, thus preventing unwanted formation of air pockets and ensuring even distribution of the liquid plastics material in the upper part of the bushing 16D. The sealing element 16F in the form of the O-ring prevents the liquid plastics material from flowing out of the upper part of the bushing 16D and escaping from the bearing space 16C. As soon as the plastics material in the bearing chamber 16C cures, an axial preload of the drive element 16 is created. At the same time, a positive connection is achieved between the cured plastics material and the tooth-like extensions 16E so that a rotation prevention mechanism is created between the drive housing 84 and the bushing 16D. Since the drive element 16 is subject to high tolerances, it is not possible to determine with certainty across a series what amount of plastics material must be introduced into the bearing space 16C. In this respect, it is preferably provided in this variant that the drive housing 84 is also adapted accordingly in order to be able to introduce the curable plastics material into the bearing space 16C. A corresponding drive housing 84 is shown in FIGS. 37A and 37B. The drive housing 84 comprises a storage tank 84B. The storage tank 84B is preferably arranged on an outer side of the drive housing 84. Specifically, the storage tank 84B may be substantially designed as a basin-like pocket on an outer side of the drive housing 84. In the bottom of the storage tank 84B, there is preferably an opening 84A, which is connected to the bearing space 16C.

The curable plastics material can thus be introduced into the bearing space 16C via the storage tank 84B and the opening 84A. When the curable plastics material is introduced into the bearing space 16C, the air in the bearing space 16C is simultaneously displaced. In order to allow the air to escape, the storage tank 84B has an outlet opening 84C in its bottom. The air escapes from the bearing space 16C via the outlet opening 84C so that said bearing space can be well filled with the curable plastics material. The storage tank 84B is used as a reservoir or excess storage for curable plastics material that remains as a residue when the bearing space 16C is filled. In this way, a uniform amount of curable plastics material for filling the bearing space 16C can be introduced, wherein the amount of curable plastics material that can actually be introduced into the bearing space varies due to the component tolerances of the drive element 16. The excess portion of the curable plastics material is then stored in the storage tank 84B and cures there.

FIG. 39A to 41 show the mounting of the spindle nut 22 in the slide assembly 26 according to a preferred exemplary embodiment. In general, the spindle nut 22 is tiltably mounted in the slide assembly 26. Specifically, the spindle nut 22 is mounted so as to be tiltable about a tilt axis K, which is aligned orthogonally to a rotational axis R of the spindle 20. The rotational axis R is shown in FIGS. 39A and 39B. The tilt axis K is shown in FIGS. 39B, 40, and 41.

As shown in the side view of FIG. 41, the spindle nut 22 has a first outer circumference 43 and a second outer circumference 45 in its cross section. The first outer circumference 43 and the second outer circumference 45 each have a common center M lying on the tilt axis K. The first outer circumference 43 is larger than the second outer circumference 45. Correspondingly to the two outer circumferences 43, 45, the slide assembly 26 has a corresponding inner contour 44. Specifically, the slide assembly 26 has an inner contour 44 that corresponds to the first outer circumference 43 and to the second outer circumference 45 and makes it possible to guide the first outer circumference 43 and the second outer circumference 45 during a tilting movement of the spindle nut 22 about the tilt axis K.

In particular, it is provided that the inner contour 44 has a first partial surface 44A, which corresponds to the first outer circumference 43. Furthermore, a second partial surface 44B, which corresponds to the second outer circumference 45, is provided on the inner contour 44. A transition surface 44C is provided between the first partial surface 44A and the second partial surface 44B. The transition surface 44C connects the first partial surface 44A to the second partial surface 44B.

The transition surface 44C is designed to limit the tilting movement about the tilt axis K. Due to the different outer circumferences of the spindle nut 22, the transition surface 44C acts as a stop for the tilting movement of the spindle nut 22. At maximum tilt of the spindle nut 22, said spindle nut thus rests against the transition surface 44C. This state is shown in FIG. 40. It can be seen that the spindle nut 22 is tilted completely and thus is in contact with the transition surface 44C. In this state, the spindle nut 22 can be inserted into the corresponding nut receptacle in the housing 24. As soon as the spindle nut 22 is deflected from the maximum tilt, i.e., in particular, is aligned with the spindle 20, as shown in FIG. 41, the contour, in particular the transition surface 44C, secures the spindle nut 22 against displacement in the housing 24 of the slide assembly 26. In other words, the inner contour 44 of the slide contour acts as a bayonet lock 22A for the spindle nut 22. For this purpose, the bayonet lock 22A has a first stop 22B, which is formed on a first side 26A of the slide assembly 26. On a second side 26B of the slide assembly, a second stop 22C is formed, which is also part of the bayonet lock 22A. The first stop 22B and the second stop 22C, which together form the bayonet lock 22A, are clearly visible in FIG. 39A. In particular, it is provided that the first stop 22B and the second stop 22C are arranged obliquely opposite one another with respect to the slide assembly 26. In its maximum tilted position, the spindle nut 22 can thus be inserted laterally into the slide assembly 26 (FIG. 39B, FIG. 40). Once the spindle nut 22 is arranged in the slide assembly 26 and deflected from the maximum tilted position, the first stop 22B and the second stop 22C prevent the spindle nut 22 from moving laterally out of the slide assembly 26.

Preferably, the first stop 22B and the second stop 22C are made in one piece or monolithically with the slide assembly 26. In particular, the slide assembly 26 with the stops 22B and 22C can be manufactured by an injection-molding process or form an injection-molded part.

FIG. 42 shows an end of the adjusting element 28 opposite the slide assembly 26. The adjusting element 28 has, at the end opposite the slide assembly 26, a joint bearing 52, which is designed to be fastened to a vehicle part or a vehicle body. For this purpose, the joint bearing 52 has a joint bearing insert 60, which encompasses the joint bearing 52 of the adjusting element 28 on the inside and forms a receptacle 60A for a joint bolt 54, which is shown in more detail in FIG. 49. The joint bearing insert 60 can basically be formed in one piece or monolithically. However, it is advantageous if the joint bearing insert 60 comprises a first joint bearing insert element 61 and a second joint bearing insert element 62. The first joint bearing insert element 61 and the second joint bearing insert element 62 can be connected to one another in a firmly bonded or positive manner. The two-part design of the joint bearing insert 60 has the advantage that the first joint bearing insert element 61 can be inserted into the joint bearing 52 from a first side, whereas the second joint bearing insert element 62 can be inserted into the joint bearing 52 from the second side. The joint bearing insert elements 61, 62 can be connected to one another within the joint bearing 52 in order to jointly form the joint bearing insert 60. Preferably, the joint bearing insert 60, in particular the first joint bearing insert element 61 and the second joint bearing insert element 62, is formed from a plastics material. The plastics material can in particular have elastic properties. It is particularly preferred if the centering contour 59B comprises a plastically deformable material, for example a plastics material. The centering contour 59B is used in particular to compensate for angular errors between the adjusting element 28 and a vehicle part or the vehicle body. Such angular errors can occur between the vehicle part and the vehicle body due to the sum of all tolerance chains and should be able to be compensated by freedom of movement in the corresponding tilting and inclination directions. At the same time, the joint bearing insert is to support the tightening torque of the screw on the retaining plate 56 without the need for a mounting template. However, the advantage of not using a mounting template is that assembly can be carried out particularly quickly and easily. In this respect, the centering contour 59B offers considerable simplification during the installation of the adjusting device in a vehicle, since it initially supports the tightening torque and can be sealed in a targeted manner during the further course of the application in order to allow the freedom of movement in the corresponding tilting and inclination directions.

The centering contour 59B may have a plurality of projections 59A, which are aligned with the joint bolt 54. In the event of an angular error during assembly, the bolt can thus be aligned within the joint bearing insert 60 since individual projections 59A of the centering contour 59B deflect accordingly. The joint bearing insert 60, with the centering contour 59B, thus ensures that a tilted arrangement between the joint bolt 54 and the adjusting element 28 is tolerated or that the pivoting movement of the adjusting element 28 relative to the joint bolt 54 is not impaired.

Referring to FIG. 43, it can be provided that the joint bearing insert 60 has a clamping unit 60E in order to clamp the joint bolt 54, which can be inserted into the bolt receptacle 60A. The clamping unit 60E can have elastic clamping elements 60F, which are arranged on an edge of the joint bearing insert 60. As can be seen in FIG. 43, the clamping unit 60E can be inserted in an upper region of the first joint bearing insert element 61. The joint bearing insert 60 substantially comprises the bolt receptacle 60A, which has an insertion opening through which the spherical portion 54C of the joint bolt 54 can be inserted. In order to prevent the joint bolt 54 from leaving the bolt receptacle 60D in the same way, the clamping unit 60E is provided. Said clamping unit is inserted into the first joint bearing insert element 61 above the bearing 60G shown in FIG. 44 and thus blocks an axial movement of the joint bolt 54 out of the bolt receptacle 60A.

FIG. 44 shows in a sectional view how the joint bolt 54 is coupled to the joint bearing insert 60 via the bearing 60G. Furthermore, it can be seen in FIG. 44 that the joint bolt 54 not only passes through the joint bearing 52 but also extends through a retaining plate 56 so that the joint bolt 54 creates a connection between the retaining plate 56 and the adjusting element 28. This is also shown again in a perspective view in FIG. 45. In addition, it can be seen in FIGS. 42 to 48 that the joint bearing insert 60 in each case has snap-on connection elements 60H, which can, for example, fix a sealing element 82 used to seal an opening in a vehicle sheet metal. By way of example, FIG. 57B shows such a sealing element 82, which is held on the adjusting element 28 by means of the snap-on connection elements 60H.

FIGS. 47 and 48 show the two joint bearing insert elements 61, 62 in detail. With respect to the first joint bearing insert element 61 (FIG. 47), an axial direction AR is shown. It can be seen that the projections 59A are formed as ribs, which extend parallel to the axial direction AR. The joint bearing insert 60 has a continuous bolt receptacle 60A, which can receive the joint bolt 54. A bayonet connection is preferably provided for connecting the joint bolt 54 to the joint bearing insert 60. The joint bolt 54 inserted in the bolt receptacle 60A can be positioned by means of the bayonet connection.

It can also be seen in FIGS. 47 and 48 that the joint bearing insert 60, in particular each of the joint bearing insert elements 61, 62, has a first locking lug 60B and a second locking lug 60C, which are arranged opposite one another on an edge of the joint bearing insert 60 or of the corresponding joint bearing insert element 61, 62. The locking lugs 60B, 60C are used as a bayonet connection to secure a spherical portion 54C of the joint bolt 54. The joint bolt 54 with the spherical portion 54C is shown in FIG. 49.

The first locking lug 60B and the second locking lug 60C may be formed adjacent to a bearing 60D, wherein the bearing 60D is arranged in the interior of the bolt receptacle 60A and receives the at least partially spherical portion 54C of the joint bolt 54. The bearing 60D is preferably formed to correspond to the spherical portion 54C of the joint bolt 54. Accordingly, the joint bolt 54 preferably has two bulges 54A arranged facing away from one another, which are designed to correspond to the first locking lug 60B and the second locking lug 60C. In this way, a bayonet connection is created between the joint bolt 54, in particular the bulges 54A, and the locking lugs 60B, 60C. A design with only one locking lug 60B is also conceivable and cannot be excluded within the scope of the invention.

The bolt receptacle 60A in the joint bearing insert 60 may have at least one notch 60D, which is used as a lubricant reservoir. The notch 60D is shown in FIG. 46, by way of example. FIG. 47 shows that the notch 60D is preferably arranged in the first joint bearing insert element 61.

FIG. 49 shows the retaining bolt 54 with the spherical portion 54C, wherein one of the two bulges 54A can be seen in the spherical portion 54C. At an upper end, the retaining bolt 54 has a retaining plate counter-contour 54B. The retaining plate counter-contour 54B corresponds in its shape to the inner contour of a retaining plate contour 56A in the retaining plate 56. The retaining plate 56 is shown in FIG. 50. In particular, it can be seen that the retaining plate 56 has two through-openings, one of the through-openings being formed with the retaining plate contour 56A. The retaining plate contour 56A is substantially designed as an oval inner contour, into which the correspondingly oval outer contour of the retaining plate counter-contour 54B engages in a positive manner. The retaining bolt 54 is thus secured against rotation and can be connected to the retaining plate 56 with a defined basic alignment.

In FIG. 51, the connection between the adjusting element 28 and the retaining plate 56 can be seen. At its end opposite the slide assembly 26, the adjusting element 28 has the joint bearing 52, in which the joint bearing insert 60 is arranged. The retaining bolt 54 penetrates the retaining plate 56, passes through the bolt receptacle 60A of the joint bearing insert 60 and subsequently engages in the second through-opening of the retaining plate 56. In addition, the open position of the bayonet lock is visible in the arrangement shown in FIG. 51. This is illustrated by the sectional view of FIG. 52. In this position, the joint bolt 54 can move axially in the joint bearing insert 60. This is the mounting position. By subsequently turning the retaining plate 56 including the joint bolt 54, the bayonet lock is locked, and the axial movement of the joint bolt 54 relative to the joint bearing insert 60 is thus blocked.

With regard to the joint bearing insert 60, it is true for all exemplary embodiments that the first joint bearing insert element 61 and the second joint bearing insert element 62 can be connected to one another in a positive or firmly bonded manner. In the case of a positive connection, it is particularly preferred if the first joint bearing insert element 61 and the second joint bearing insert element 62 can be connected to one another by a screw connection. For this purpose, the first joint bearing insert element 61 can, for example, have an external thread, which cooperates with a corresponding internal thread of the second joint bearing insert element 62.

FIGS. 53 and 54 show a further exemplary embodiment, which relates to the closure of the housing 24 of the slide assembly 26 by the cover 64. The housing 24 is preferably designed as an extruded profile and therefore has open axial ends. In order to prevent both moisture and dust from entering the housing 24, a cover 64 is therefore provided. Specifically, the housing 24 has a housing opening 24C (FIG. 27), which can be sealed by the cover 64. The cover 64 preferably has projections 64A, which can be connected to the receptacle 37A of the housing 24. In their basic contour, the projections 64A therefore preferably correspond to the guide elements 37C, 37D, 37E of the guide device 37B so that the projections 64A can be inserted into the longitudinal grooves 37 of the receptacle 37A. Preferably, multiple such projections 64A are formed on the cover 64. In particular, the number of projections 64A preferably corresponds to the number of longitudinal grooves 37 in the housing 24. In the specific exemplary embodiment as shown in FIGS. 53 and 54, seven projections 64A are provided which cooperate, respectively, with seven longitudinal grooves 37. In order to facilitate the insertion of the projections 64A into the longitudinal grooves 37, they preferably have a conical or frustoconical taper at their free ends. Furthermore, it can be provided that the cover-side projections 64A comprise preloading elements 64H in the form of ribs, which are formed in the longitudinal direction of the projection 64A. The preloading elements 64H, which are similar to the preloading elements 37H, are preferably formed monolithically with the projections 64A. The projections 64A can also be formed monolithically with the cover 64. For fixing the cover 64 to the housing 24, it can be provided that the longitudinal grooves 37 are crimped in the regions in which the projections 64A are inserted into the longitudinal grooves 37. By crimping, i.e., reshaping the longitudinal grooves 37, a positive connection to the projections 64A is created so that the cover 64 is thus firmly attached to the housing 24.

In FIG. 53, it can also be seen that the cover 64 has a drainage opening 64C. Since ingress of moisture into the housing 24, in particular condensation, cannot be completely avoided, the drainage opening 64C is provided. Said drainage opening allows moisture to drain out of the housing 24. As already explained in connection with FIG. 24, the slide assembly 26 preferably has a piston geometry 72 whose outer contour corresponds to the inner contour of the drainage opening 64C, so that the piston geometry 72 seals the drainage opening 64 in an end position of the slide assembly 26. For this purpose, it is advantageously provided that the piston geometry 72 has a radial seal 73.

The preloading elements 64H on the projections 64A are used, on the one hand, to compensate for tolerances and thus to ensure secure, rattle-free fastening of the cover 64. At the same time, the preloading elements 64H provide a preload, which also reduces any rattling noises.

The cover 64 further comprises a collar 64B, which encompasses a longitudinal end of the housing 24 on its perimeter and thus further impedes the ingress of moisture into the housing 24. In this respect, the collar 64B is water-repellent.

FIGS. 55 to 57B show an embodiment of an adjusting device 10, in which a sealing element 82 is arranged on the adjusting element 28. The sealing element 82 can be fastened to the adjusting element 28 in particular by means of the snap-on connection elements 60H shown in FIG. 48. The sealing element 82 is used in particular to seal a first cavity, preferably a vehicle cavity, which receives the joint bearing 52. Specifically, the sealing element 82 is used to seal an opening of the first cavity. The sealing element 82 can be locked to the joint bearing insert 60 by the snap-on connection elements 60H. The sealing element 82 completely encompasses the adjusting element 28 in order to ensure a good seal between the adjusting element 28 and an opening of the first cavity. Additionally or alternatively, the sealing element 82 can be provided for sealing a second cavity of a body or a vehicle part that is movable relative to a body of a vehicle and in which the adjusting device 10 is arranged.

As can be seen in FIG. 55, the sealing element 82 has a first sealing lip 82A, which rests directly against the adjusting element 28. Furthermore, a second sealing lip 82B is provided, which is arranged along a peripheral direction of the sealing element 82. The second sealing lip 82B seals against the opening of the vehicle cavity. In general, the sealing element 82 comprises a base body 82D, which extends into a base plane G. Furthermore, a central body 82E is provided, which encompasses the adjusting element 28 and comprises the first sealing lip 82A. The central body 82E is oriented along a longitudinal direction L of the adjusting element 28. The longitudinal direction L of the adjusting element 28 can be seen in FIG. 57B.

In FIG. 57A, it is clearly visible that the base plane G of the base body 82D and the longitudinal direction L of the adjusting element 28 are arranged at an angle to one another that is different from 90°. This is accompanied by an oblique alignment of the central body 82E relative to a plane which includes the second sealing lip 82B. This tilting or this oblique arrangement is particularly advantageous for sealing cavities in vehicles that receive the joint bearing 52. The adjusting device is preferably used to operate vehicle doors or vehicle flaps that are aligned at an angle to a vehicle body when opened. This angular alignment can be compensated by the oblique arrangement of the second sealing lip 82B with respect to the central body 82E so that the sealing element 82 ensures a permanently good seal.

In FIG. 57A, it can also be seen that the sealing element 82 has a locking arrangement 82C, which cooperates with the snap-on connection elements 60H of the joint bearing insert 60 in order to produce a positive connection between the sealing element 82 and the joint bearing insert 60. Furthermore, the central body 82E can be arranged off-center on the base body 82D.

FIGS. 58 and 59 also show the sealing arrangement 34 (already shown in FIG. 22), which completely surrounds the adjusting element 28 and protects an interior of the housing 24 against environmental influences. The sealing arrangement 34 has a fastening portion 67 with which the sealing arrangement 34 can be fastened to the housing 24. Furthermore, a bellows portion 69 is provided, which ensures mobility of the sealing arrangement 34. In particular, tilting movements of the adjusting element 28 relative to the housing 24 can thus be compensated. Furthermore, a wiper portion 68 is provided, which slides along the adjusting element 28 but at the same time forms a sliding seal.

In order to ensure that, even in the installed state, the adjusting device 10 can be clearly identified, for example by a workshop employee, without having to remove it from the vehicle or the side door, a suitable marking of the adjusting device 10 is provided. However, since these markings should not be visible to an end customer of the vehicle, instead of or in addition to the adjusting element 28, the sealing element 82 can advantageously be labeled on a side wall that, in the installed state, faces away from the passenger compartment of the vehicle. In the installed state, this side wall of the sealing element 82 faces, for example, the side door and is not visible to an end customer/driver of the vehicle. If the adjusting device 10 is arranged, tilted by 180°, on the other vehicle side, the marking is also located on the side wall of the sealing element 28 that faces away from the passenger compartment.

As a further advantageous labeling method, it is conceivable to label the sealing element 28 by means of a suitable lacquer, which can only be made visible when using a suitable light source. For example, a UV varnish can be used, which only becomes visible with the aid of a UV lamp.

FIGS. 60 and 61 show an exemplary embodiment of the adjusting device 10, in which the slide assembly 26 has two guide portions 32. A first, left-hand guide portion 32A, 32B is opposite a second right-hand guide portion 32B. The guide portions 32A, 32B are used to guide the slide assembly 26 in the housing 24. Each of the two guide portions 32A, 32B is assigned a guide rail 74A, 74B arranged without play. The guide rails 74A, 74B each have a prismatic shape and thus form prismatic sliding or guide surfaces 75, which cooperate with sliding or guide surfaces 77 (see FIG. 26) of the housing 24. In particular, the guide rails 74A, 74B preferably comprise a trapezoidal outer contour on the sides facing the housing inner surfaces. In addition to the two opposite guide portions 32A, 32B and the respective guide rails 74A, 74B assigned to them, a third guide portion 32C can be provided, which guides the slide assembly 26 in the housing. The three guide portions 32A, 32B, 32C can thus substantially form a three-point sliding bearing in the housing 24. The third guide portion 32C preferably also has a guide rail 74C. The guide rails 74A, 74B, 74C are each arranged without play on the guide portions 32A, 32B, 32C assigned to them. It is also possible that one of the guide rails 74, 74A, 74B is formed in one piece with the corresponding guide portion 32A, 32B, 32C.

In the exemplary embodiment as shown in FIGS. 60 and 61, at least one of the guide rails 74A, 74B, 74C, in particular the guide rail 74B of the second guide portion 32B, has a means for self-adjusting play reduction. Preferably, the opposite guide rail 74B can also have such means for self-adjusting play reduction. The means for self-adjusting play reduction preferably each comprise an elastic spring element 80 shown in FIG. 26. The elastic spring element 80 can act on a compensating element 76, which is designed to be relatively movable between the at least one guide rail 74 and the prismatic guide surface 77 in the form of a corresponding sliding surface of the housing 24. The compensating element 76 may specifically comprise a first compensating element 76A and a second compensating element 76B, which are formed independently of one another. The compensating elements 76A, 76B are preferably arranged, spaced apart at an offset from one another in the longitudinal direction, along a guide rail 74A, 74B, 74C. The compensating elements 76, 76A, 76B are preferably preloaded by the spring element 80 and press against the inner guide surfaces 77 of the housing 24 so that tolerance compensation is achieved in this way. The slide assembly 26 is thus guided well in the housing 24, which avoids noise emissions due to play. In addition to the freedom from play, the prismatic design can provide increased stability of the slide assembly 26 in the housing 24 so that a uniform linear movement can be carried out independently of external forces. This is based on the physical wedge principle of holding large displacement forces with a small holding force of the spring elements 80.

Furthermore, the compensating elements 76, which are preloaded to the housing 24 by the spring elements 80, are used as a defined linear brake on the movement axis of the adjusting element 28 by means of a defined frictional/braking force that is coordinated with the adjusting device 10. Due to the friction introduced there, the entire system of the adjusting device 10 is damped and can be better controlled by an external control, whereby noise generation can be avoided. Due to the simple and modular design of the system, the spring elements 80 can be easily replaced and designed to meet the particular requirements of the adjusting device 10. Like the embodiment as shown in FIGS. 25 and 26, this embodiment allows a virtually play-free linear guide of the slide assembly 26 as well as a defined, constant frictional torque between the slide assembly 26 and the housing 24 so that a necessary holding force, for example of a vehicle door, can be fully or partially achieved. The friction introduced into the slide assembly 26 can therefore substitute for a separate brake, for example a magnetic brake, in the region of the drive unit 14. A further advantage of applying friction at this point of action of the adjusting device 10 is a uniform basic load, which leads to quieter running of the entire system.

Each compensating element 76, 76A, 76B may also have an assembly phase 76C in order to be able to insert the slide assembly 26 into the housing 24. The assembly phase 76C causes the compensating element 76, 76A, 76B to be displaced inward against the spring force of the spring element 80 when the slide assembly 26 is inserted into the housing 24, and then, due to the spring element 80, rests against the guide surface 77 in the interior of the housing 24. On a side facing away from the guide surface 77, each compensating element 76 can additionally have a locking pin 81, which secures the ball bolt 38 inserted into the ball socket 40. The locking pin 81 can thus substantially form the fastening element 39C, which holds the partially spherical portion of the ball bolt 38 in the ball socket 40 (FIG. 34). In this way, the compensating elements 76 offer a dual function, namely, on the one hand, the tolerance compensation for the slide assembly in the housing 24 and, on the other hand, the fastening of the ball bolt 38 in the ball socket 40.

1. Adjusting device for a vehicle part that is movable relative to a body of a vehicle, comprising:
a housing with a slide assembly, wherein the slide assembly can be transferred between a first position and a second position by means of a drive unit; and
an adjusting element, which is designed to be connectable to the slide assembly and the body of a vehicle or a vehicle part that is movable relative to the body of a vehicle,
wherein a fastening element for fastening the adjusting device to a body of a vehicle or to a vehicle part that is movable relative to the body of a vehicle, wherein the fastening element is designed to be connectable to the housing in a frictional and/or positive manner and the housing has at least one receptacle for guiding the fastening element along a longitudinal direction (L) of the housing.

2. (canceled)

3. Adjusting device according to claim 1, wherein the fastening element comprises at least one guide device for insertion into the receptacle.

4. Adjusting device according to claim 3, wherein the guide device has a first guide element and a second guide element.

5. Adjusting device according to claim 4, wherein the first guide element and the second guide element can be inserted into the receptacle on opposite sides of the housing in a cross-sectional view.

6. Adjusting device according to claim 4, wherein the receptacle of the housing has at least two longitudinal grooves, which correspond to the first guide element and the second guide element.

7. Adjusting device according to claim 4, wherein the guide elements are arranged parallel to one another.

8. Adjusting device according to claim 4, wherein at least one guide element is conically shaped at a first end and at a second end.

9. Adjusting device according to claim 4, wherein a guide element has a preloading element for generating a preload of the fastening element relative to the housing.

10. Adjusting device according to claim 1, wherein the fastening element is fixed to the housing by crimping a receptacle with an inserted guide element.

11. Adjusting device according to claim 1, wherein the fastening element is fixed to the housing by riveting.

12. Adjusting device according to claim 1, wherein the housing is made of an aluminum profile.

13. Adjusting device according to claim 1, wherein the fastening element has a threaded portion with a funnel-shaped feed for fastening to a body of a vehicle or to a vehicle part that is movable relative to the body of a vehicle.

14. Adjusting device according to claim 13, wherein the fastening element is manufactured by means of an injection-molding process, and wherein the threaded portion has an overmolded nut.

15. Adjusting device according to claim 1, wherein the fastening element comprises a holding means for cables.

16. Vehicle with an adjusting device for a vehicle part that is movable relative to the body of the vehicle according to claim 1.
